(19) United States
(12) Patent Application Publication
(10) Pub. No.: US 2021/0373292 A1
(43) Pub. Date: Dec. 2, 2021

(54) OPTICAL LENS

(71) Applicant: Rays Optics Inc., Hsinchu County (TW)

(72) Inventors: YING-HSIU LIN, Hsinchu County (TW); HUNG-YOU CHENG, Hsinchu County (TW); CHIA-CHEN KUNG, Hsinchu County (TW); CHEN-CHENG LEE, Hsinchu County (TW); KUO-CHUAN WANG, Hsinchu County (TW)

(21) Appl. No.: 17/220,124

(22) Filed: Apr. 1, 2021

(30) Foreign Application Priority Data
May 29, 2020 (TW) 109118102

(51) Int. Cl. G02B 13/00; G02B 9/64

(52) U.S. Cl. CPC G02B 13/0045; G02B 9/64

(57) ABSTRACT

An optical lens includes a first lens, a second lens, a third lens, a fourth lens, a first cemented lens and aperture stop. The first lens is closest to a magnified side of the optical lens, one of the second lens and the third lens is a first aspheric lens, and the fourth lens is a second aspheric lens and disposed between the first cemented lens and a minified side of the optical lens. The optical lens has at most two plastic lenses, and the optical lens satisfies the condition of 3.5<D1/DL<5.5, where D1 denotes a lens diameter of the first lens and DL denotes a lens diameter of the fourth lens.

### BACKGROUND OF THE INVENTION

### a. Field of the Invention

The invention relates generally to an optical system, and more particularly to an optical lens.

### b. Description of the Related Art

Recent advances in technology have led to the development of various types of imaging lenses. For example, an image pick-up lens used in smart-home appliances, access controls, surveillance cameras, in-vehicle cameras or action cameras is a commonly used optical lens. Nowadays, there is a growing need for the image pick-up lens to be miniaturized and have high optical performance. To meet these requirements, the optical lens needs to have, for example, low fabrication costs, high resolution, large effective aperture, wide viewing angles, low thermal drift, 24-hours confocal image-capturing capability, a short total track length, a long back focus length, and a miniaturized layout. Therefore, it is desirable to provide an imaging lens that may achieve lower fabrication costs, wider viewing angles, lower thermal drift, a shorter total track length, a longer back focus length, a miniaturized layout, 24-hours confocal image-capturing capability and better imaging quality.

### BRIEF SUMMARY OF THE INVENTION

According to one aspect of the present disclosure, an optical lens includes a first lens, a second lens, a third lens, a fourth lens, a first cemented lens and aperture stop. The first lens is closest to a magnified side of the optical lens, one of the second lens and the third lens is a first aspheric lens, and the fourth lens is a second aspheric lens and disposed between the first cemented lens and a minified side of the optical lens. The aperture stop is disposed between the third lens and the first cemented lens, a full field of view of the optical lens is greater than or equal to 170 degrees, and a total number of lenses with refractive powers in the optical lens is in the range of seven to eleven. The optical lens has at most two plastic lenses, and the optical lens satisfies the condition: 3.5<D1/DL<5.5, where D1 denotes a lens diameter of the first lens and DL denotes a lens diameter of the fourth lens.

According to another aspect of the present disclosure, an optical lens includes a first lens group and a second lens group. The first lens group includes three spherical lenses and an aspheric lens, and the second lens group includes a cemented lens. The aperture stop is disposed between the first lens group and the second lens group, the optical lens includes at most two plastic lenses, a total number of lenses with refractive powers in the optical lens is in the range of seven to eleven, an F-number of the optical lens is smaller than or equal to 2.0, a full field of view of the optical lens is greater than or equal to 170 degrees, and a relative illumination of the optical lens measured at a field of view of 170 degrees is greater than 60%.

According to another aspect of the present disclosure, an optical lens includes a first lens with a negative refractive power, a second lens with a negative refractive power, a third lens with a negative refractive power, a fourth lens with a positive refractive power, a fifth lens with a refractive power, a sixth lens with a refractive power and a seventh lens with a positive refractive power arranged in order in a direction. At least two of the first lens, the second lens and the third lens are glass spherical lens, the fifth lens and the sixth lens are combined to form a cement lens, and the seventh lens is an aspheric lens. An aperture stop is disposed between the fourth lens and the fifth lens, a total number of lenses with refractive powers in the optical lens is no more than eleven, and the optical lens has at most two plastic lenses.

According to the above aspects, the optical lens may achieve good imaging quality, low thermal drift, low fabrication costs, wide viewing angles and 24-hours confocal image-capturing capability. Further, according to the above embodiments, the optical lens is allowed to operate in a wide temperature range of −40° C. to 105° C.

Other objectives, features and advantages of the invention will be further understood from the further technological features disclosed by the embodiments of the invention wherein there are shown and described preferred embodiments of this invention, simply by way of illustration of modes best suited to carry out the invention.

### BRIEF DESCRIPTION OF THE DRAWINGS

FIG. 1 shows a cross-sectional illustration of an optical lens according to a first embodiment of the invention.

FIG. 2 shows a cross-sectional illustration of an optical lens according to a second embodiment of the invention.

FIG. 3 shows a cross-sectional illustration of an optical lens according to a third embodiment of the invention.

FIG. 4 shows a cross-sectional illustration of an optical lens according to a fourth embodiment of the invention.

FIG. 5 shows a cross-sectional illustration of an optical lens according to a fifth embodiment of the invention.

FIG. 6 shows a cross-sectional illustration of an optical lens according to a sixth embodiment of the invention.

FIG. 7 shows a cross-sectional illustration of an optical lens according to a seventh embodiment of the invention.

FIG. 8 shows a cross-sectional illustration of an optical lens according to an eighth embodiment of the invention.

FIG. 9 shows a cross-sectional illustration of an optical lens according to a ninth embodiment of the invention.

FIG. 10 shows a cross-sectional illustration of an optical lens according to a tenth embodiment of the invention.

FIG. 11 shows a ray fan plot of the first embodiment.

FIG. 12 shows a focus shift plot of the first embodiment.

FIG. 13 shows numerical values of relative illumination at different image heights of an image plane according to the first embodiment.

FIG. 14 shows a ray fan plot of the second embodiment.

FIG. 15 shows a focus shift plot of the second embodiment.

FIG. 16 shows numerical values of relative illumination at different image heights of an image plane according to the second embodiment.

FIG. 17 shows a ray fan plot of the third embodiment.

FIG. 18 shows a focus shift plot of the third embodiment.

FIG. 19 shows numerical values of relative illumination at different image heights of an image plane according to the third embodiment.

### DETAILED DESCRIPTION OF THE INVENTION

In the following detailed description of the preferred embodiments, directional terminology, such as “top,” “bottom,” “front,” “back,” etc., is used with reference to the orientation of the Figure(s) being described. The components of the invention can be positioned in a number of different orientations. As such, the directional terminology is used for purposes of illustration and is in no way limiting. Further, “First,” “Second,” etc, as used herein, are used as labels for nouns that they precede, and do not imply any type of ordering (e.g., spatial, temporal, logical, etc.). The following embodiments of a zoom lens may be applied to any system or environment according to actual demands.

In an imaging system, a magnified side may refer to one side of an optical path of an imaging lens comparatively near a subject to be picked-up, and a minified side may refer to other side of the optical path comparatively near a photosensor.

A certain region of an object side surface (or an image side surface) of a lens may be convex or concave. Herein, a convex or concave region is more outwardly convex or inwardly concave in the direction of an optical axis as compared with other neighboring regions of the object/image side surface.

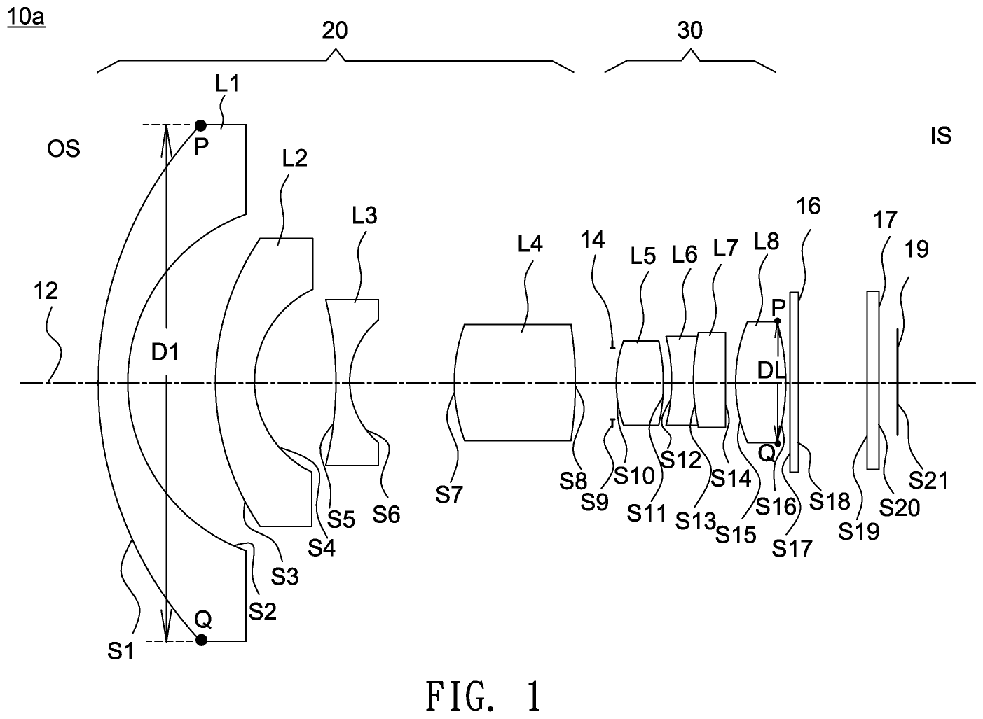

FIG. 1 shows a cross-sectional illustration of an optical lens according to a first embodiment of the invention. As shown in FIG. 1, in this embodiment, the optical lens 10a has a lens barrel (not shown), and inside the lens barrel a first lens L1, a second lens L2, a third lens L3, a fourth lens L4, an aperture stop 14, a fifth lens L5, a sixth lens L6, a seventh lens L7 and an eighth lens L8 are arranged in order from a first side (magnified side OS) to a second side (minified side IS). In this embodiment, the first lens L1, the second lens L2, the third lens L3, the fourth lens L4, the fifth lens L5, the sixth lens L6, the seventh lens L7 and the eighth lens L8 have negative, negative, negative, positive, positive, negative, positive and positive refractive powers, respectively. The first lens L 1, the second lens L2, the third lens L3 and the fourth lens L4 form a first lens group 20 (such as a front lens group) with a negative refractive power, the fifth lens L5, the sixth lens L6, the seventh lens L7 and the eighth lens L8 form a second lens group 30 (such as a rear lens group) with a positive refractive power. Further, the minified side IS is disposed with a optical filter 16, a cover glass 17 and a photosensor (not shown), an image plane (visible-light focal plane) of the optical lens 10a formed at an effective focal length for visible light is labeled as 19, and the optical filter 16 is disposed between the second lens group 30 and the image plane 19. In this embodiment, all lenses L1-L8 are glass lenses, and the second lens L2 and the eighth lens L8 are aspheric lenses. In other embodiment, at least one glass lens may be replaced with a plastic lens. Further, adjoining surfaces of each two adjacent lenses may have an identical radius of curvature or a similar radius of curvature (a radius difference smaller than 0.005 mm) to form a compound lens (such as a cemented lens, a doublet lens, a triplet lens or even higher number lens configurations). In this embodiment, the sixth lens L6 and the seventh lens L7 are combined together to form a cemented doublet, but the invention is not limited thereto. Further, in each of the following embodiments, the magnified side OS is located on the left side and the minified side IS is located on the right side of each figure, and thus this is not repeatedly described in the following for brevity.

The aperture stop 14 is an independent component or integrally formed with other optical element. In this embodiment, the aperture stop may use a mechanic piece to block out peripheral light and transmit central light to achieve aperture effects. The mechanic piece may be adjusted by varying its position, shape or transmittance. In other embodiment, the aperture stop may be formed by applying an opaque or a light-absorbing material on a lens surface except for a central area to block out peripheral light and transmits central light.

Each lens may be assigned a parameter of “lens diameter”, and the “lens diameter” is defined by a distance between outermost turning points of the optical lens at each end of the optical axis 12. For example, as shown in FIG. 1, the magnified-side surface of the first lens L1 (the lens furthest from the aperture stop 14 among all lenses in the first lens group 20) has two opposite turning points P and Q (outermost turning points) that are spaced at a distance measured in a direction perpendicular to the optical axis 12, and such distance is referred to as a lens diameter D1 of the lens L1. Besides, the minified-side surface of the eighth lens L8 (the lens furthest from the aperture stop 14 among all lenses in the second lens group 30) has two opposite turning points P and Q (outermost turning points) that are spaced at a distance measured in a direction perpendicular to the optical axis 12, and such distance is referred to as a lens diameter DL of the seventh lens L8. In this embodiment, the first lens L1 (closest to the magnified side among all lenses of the optical lens) has a diameter D1 of 20.1mm, and the eighth lens L8 (closest to the minified side among all lenses of the optical lens) has a diameter DL of 4.8mm.

A spherical lens indicates its front lens surface and rear lens surface are each a part surface of a sphere having a fixed radius of curvature. In comparison, an aspheric lens indicates at least one of its front lens surface and rear lens surface has a radius of curvature that varies along a center axis to correct abbreviations. Detailed optical data, design parameters and aspheric coefficients of the optical lens 10a are shown in Tables 1 and 2 below. In the following design examples of the invention, each aspheric surface satisfies the following equation:

$$Z = \frac{{cr}^{2}}{1 + \sqrt{1 - ( 1 + k ) {c}^{2} {r}^{2}}} + {Ar}^{4} + {Br}^{6} + {Cr}^{8} + {Dr}^{10} + {Er}^{12} + {Fr}^{14} + {Gr}^{16} + … ,$$

where Z denotes a sag of an aspheric surface along the optical axis 12, c denotes a reciprocal of a radius of an osculating sphere, K denotes a Conic constant, r denotes a height of the aspheric surface measured in a direction perpendicular to the optical axis 12, and parameters A-G are 4th, 6th, 8th, 10th, 12th, 14th and 16th order aspheric coefficients. Note the data provided below are not used for limiting the invention, and those skilled in the art may suitably modify parameters or settings of the following embodiment with reference of the invention without departing from the scope or spirit of the invention.

TABLE 1
D1 = 20.1 mm; DL = 4.8 mm; D1/DL = 4.2; F# = 2.0

| | Radius | Interval | Refractive | Abbe | Object |
|---|---|---|---|---|---|
| Surface | (mm) | (mm) | index | number | description |
| 1 | 15.26 | 1.15 | 2.00 | 25.5 | meniscus(L1) |
| 2 | 7.09 | 3.20 | | | |
| 3* | 9.44 | 1.44 | 1.77 | 49.8 | aspheric(L2) |
| 4* | 3.19 | 3.00 | | | |
| 5 | −12.93 | 0.60 | 1.50 | 81.5 | biconcave(L3) |
| 6 | 3.45 | 4.02 | | | |
| 7 | 9.56 | 4.29 | 1.92 | 20.9 | biconvex(L4) |
| 8 | −23.36 | 1.50 | | | |
| 9 | inf. | 0.10 | | | aperture stop14 |
| 10 | 5.07 | 1.86 | 1.50 | 81.5 | biconvex(L5) |
| 11 | −5.07 | 0.27 | | | |
| 12 | −4.65 | 0.60 | 1.85 | 23.8 | biconcave(L6) |
| 13 | 4.65 | 1.41 | 1.60 | 67.7 | biconvex(L7) |
| 14 | −20.70 | 0.20 | | | |
| 15* | 4.17 | 2.13 | 1.50 | 81.5 | aspheric(L8) |
| 16* | −5.24 | 0.10 | | | |
| 17 | inf. | 0.30 | 1.52 | 64.1 | optical filter 16 |
| 18 | inf. | 2.50 | | | |
| 19 | inf. | 0.50 | 1.52 | 64.1 | cover glass 17 |
| 20 | inf. | 0.63 | | | |
| 21 | | | | | image plane 19 |

In the above Table 1, an interval of the surface S1 is a distance between the surface S1 and the surface S2 along the optical axis 12, an interval of the surface S2 is a distance between the surface S2 and the surface S3 along the optical axis 12, and an interval of the surface S20 is a distance between the surface S20 and the image plane 19 along the optical axis 12. Table 2 lists aspheric coefficients and conic constant of each aspheric surface of the optical lens 10a according to the first embodiment of the invention.

TABLE 2

| Surface | K | A | B | C | D | E |
|---|---|---|---|---|---|---|
| S3 | −3.70 | 1.02E−03 | −4.55E−05 | 8.07E−07 | −4.39E−09 | — |
| S4 | −1.21 | 2.68E−03 | 1.21E−04 | −2.74E−05 | 1.45E−06 | −3.18E−08 |
| S15 | −0.70 | −2.60E−03 | 2.93E−04 | −1.73E−05 | 3.06E−06 | — |
| S16 | −6.55 | −2.25E−03 | 5.52E−04 | −6.05E−05 | 7.11E−06 | — |

In the above table 1, the surface denoted by an asterisk is an aspheric surface, and a surface without the denotation of an asterisk is a spherical surface.

The radius of curvature is a reciprocal of the curvature. When a lens surface has a positive radius of curvature, the center of the lens surface is located towards the minified side. When a lens surface has a negative radius of curvature, the center of the lens surface is located towards the magnified side. The concavity and convexity of each lens surface is listed in each table and shown in corresponding figures.

The Symbol F/# shown in the above table is an F-number. When the optical lens is used in an image pick-up system, the image plane is a sensing surface of a photosensor. In one embodiment, an F-number of the optical lens is smaller than or equal to 2.0.

A full field of view is a light collection angle of the optical surface S1 closest to the magnified side and is measured diagonally. In one embodiment, the full field of view (FOV) is larger than or equal to 170 degrees. In another embodiment, the full field of view is larger than 180 degrees. In one embodiment, a relative illumination (RI) measured at a field of view of 170 degrees relative to the optical axis (0 degree field of view) is greater than 60%.

In one embodiment, the optical lens may include two lens groups, and the front lens group may include at least one lens with a negative refractive power to enhance light collection capability and achieve a wide field of view, but the invention is not limited thereto. In one embodiment, an F-number of the optical lens is substantially smaller than or equal to 2.0. The rear lens group may have at least one compound lens (such as a cemented lens, a doublet lens or a triplet lens) to correct chromatic aberrations, and a minimum distance between two lenses of a doublet lens along an optical axis is smaller than or equal to 0.01mm. Adjoining surfaces of each two adjacent lenses of the doublet lens, triplet lens or even higher number lens configurations may have an identical or a similar radius of curvature. In one embodiment, a difference in Abbe number between two lenses of a cemented lens in the rear lens group is greater than 40 to correct chromatic aberrations; in other embodiment, such difference in Abbe number is greater than 50 to correct chromatic aberrations; in still other embodiment, such difference in Abbe number is greater than 60 to correct chromatic aberrations. Further, a total number of lenses with refractive powers in the optical lens is in the range of seven to eleven (7-11). In one embodiment, the front lens group may have at least one aspheric lens, and the rear lens group may have has at least one aspheric lens to correct aberrations. In one embodiment, the optical lens includes at most two plastic lenses. In one embodiment, by matching the coefficients dn/dt for glass lenses in an optical lens, where do denotes a variation in the refractive index of a lens at a temperature variation dt of the lens, a thermal drift of the optical lens measured by a shift distance between a focal plane at 25 degrees and a focal plane at 105 degrees is smaller than or equal to 10 um. The optical lens according to various embodiments of the invention is allowed to operate in the range of −40° C. to 105° C. The optical lens according to various embodiments of the invention can be applied to a 24-hours confocal image-capturing system, where a displacement between a focal plane for 450 nm visible light and a focal plane for 550 nm visible light is smaller than or equal to 10 um, and a displacement between a focal plane for infrared light (850 nm) and a focal plane for visible light (550 nm) is smaller than or equal to 10 um. In one embodiment, the amount of lateral chromatic aberration between 450 nm visible light and 550 nm visible light is smaller than 3 um. In one embodiment, the amount of lateral chromatic aberration between 550 nm visible light and 650 nm visible light is smaller than 3 um.

In one embodiment, the optical lens may satisfy a condition of 3.5<D1/DL<5.5, a further condition of 3.45<D1/DL<5.6, and a still further condition of 3.4<D1/DL<5.7, where D1 is a lens diameter of the lens closest to the magnified side, and DL is a lens diameter of the lens closest to the minified side. Meeting the above conditions may facilitate light converging capability of lenses to reduce the scope of image beams passing through lenses to match the size of a photosensor and thus allow for better optical performance in a limited space.

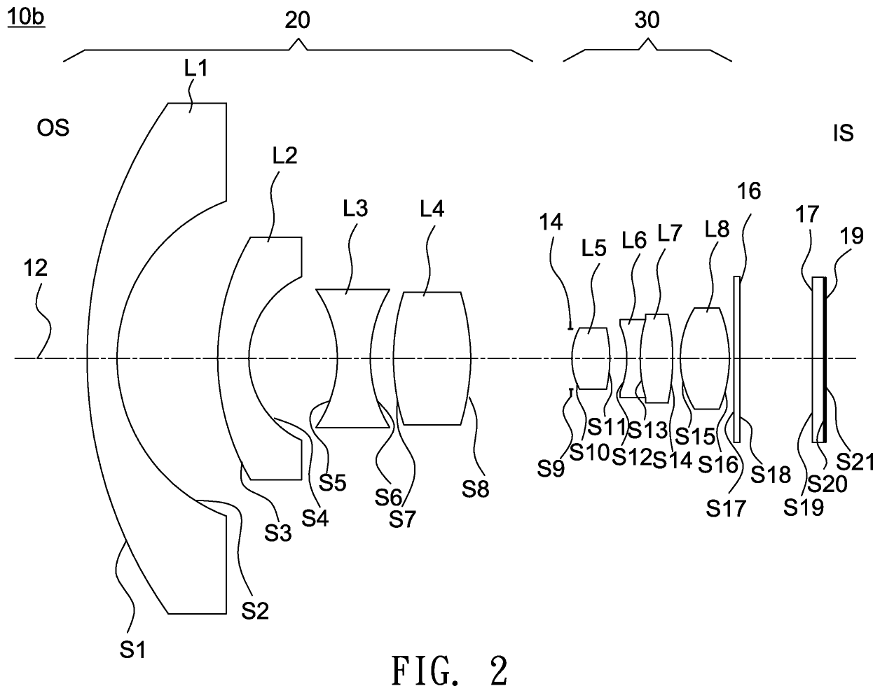

FIG. 2 shows a cross-sectional illustration of an optical lens according to a second embodiment of the invention. As shown in FIG. 2, in this embodiment, the optical lens 10b includes a first lens L1, a second lens L2, a third lens L3, a fourth lens L4, an aperture stop 14, a fifth lens L5, a sixth lens L6, a seventh lens L7 and an eighth lens L8. In this embodiment, the first lens L1, the second lens L2, the third lens L3 and the fourth lens L4 form a first lens group 20 with a negative refractive power, the fifth lens L5, the sixth lens L6, the seventh lens L7 and the eighth lens L8 form a second lens group 30 with a positive refractive power, and the first lens L1, the second lens L2, the third lens L3, the fourth lens L4, the fifth lens L5, the sixth lens L6, the seventh lens L7 and the eighth lens L8 have negative, negative, negative, positive, positive, negative, positive and positive refractive powers, respectively. In this embodiment, all lenses L1-L8 are glass lenses. In other embodiment, at least one glass lens may be replaced with a plastic lens. In this embodiment, the second lens L2 and the eighth lens L8 are aspheric lenses, and the sixth lens L6 and the seventh lens L7 are fit together to form a cemented doublet, but the invention is not limited thereto. In this embodiment, the first lens L1 (closest to the magnified side among all lenses of the optical lens) has a diameter D1 of 21.6 mm, and the eighth lens L8 (closest to the minified side among all lenses of the optical lens) has a diameter DL of 4.8 mm. Detailed optical data, design parameters and aspheric coefficients of the optical lens 10b are shown in Table 3 below.

TABLE 3
D1 = 21.6 mm; DL = 4.8 mm; D1/DL = 4.5; F# = 2.0

| | Radius | Interval | Refractive | Abbe | Object |
|---|---|---|---|---|---|
| Surface | (mm) | (mm) | index | number | description |
| 1 | 18.99 | 1.20 | 1.92 | 24.0 | meniscus(L1) |
| 2 | 7.27 | 4.24 | | | |
| 3* | inf. | 1.19 | 1.80 | 40.7 | aspheric(L2) |
| 4* | 4.94 | 3.55 | | | |
| 5 | −5.57 | 1.39 | 1.50 | 81.5 | biconcave(L3) |
| 6 | 5.57 | 1.00 | | | |
| 7 | 14.00 | 3.00 | 2.05 | 26.9 | biconvex(L4) |
| 8 | −10.40 | 4.10 | | | |
| 9 | inf. | 0.10 | | | aperture stop14 |
| 10 | 3.87 | 1.45 | 1.44 | 95.1 | biconvex(L5) |
| 11 | −6.16 | 0.74 | | | |
| 12 | −4.34 | 0.60 | 1.85 | 23.8 | biconcave(L6) |
| 13 | 7.27 | 1.49 | 1.60 | 67.7 | biconvex(L7) |
| 14 | −7.27 | 0.10 | | | |
| 15* | 5.25 | 1.84 | 1.50 | 81.5 | aspheric(L8) |
| 16* | −6.14 | 0.10 | | | |
| 17 | inf. | 0.30 | 1.52 | 64.1 | optical filter 16 |
| 18 | inf. | 2.95 | | | |
| 19 | inf. | 0.40 | 1.52 | 64.1 | cover glass17 |
| 20 | inf. | 0.05 | | | |
| 21 | | | | | image plane19 |

In the above Table 3, an interval of the surface S1 is a distance between the surface S1 and the surface S2 along the optical axis 12, an interval of the surface S2 is a distance between the surface S2 and the surface S3 along the optical axis 12, and an interval of the surface S20 is a distance between the surface S20 and the image plane 19 along the optical axis 12. Table 4 lists aspheric coefficients and conic constant of each aspheric surface of the optical lens 10b according to the second embodiment of the invention.

TABLE 4

| Surface | K | A | B | C | D | E |
|---|---|---|---|---|---|---|
| S3 | 0 | 8.09E−03 | −6.19E−04 | 2.47E−05 | −5.09E−07 | 4.34E−09 |
| S4 | −0.04 | 9.72E−03 | 2.81E−04 | −2.08E−04 | 1.92E−05 | −5.84E−07 |
| S15 | −1.60 | −8.41E−04 | −1.53E−04 | 5.44E−05 | −5.31E−06 | — |
| S16 | −4.66 | 1.52E−03 | −3.99E−04 | 9.67E−05 | −6.98E−06 | — |

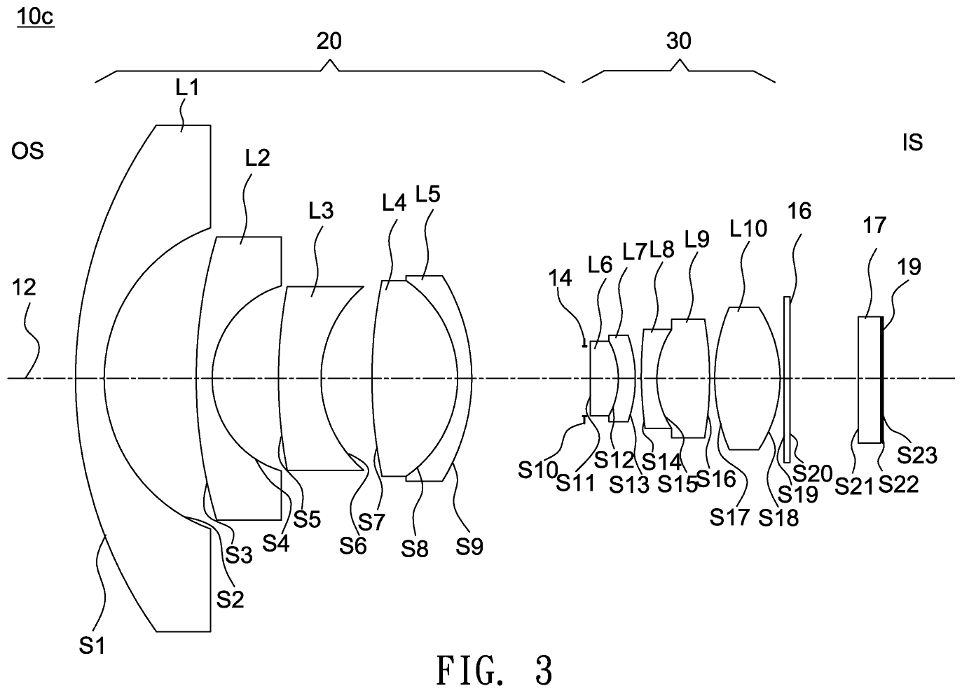

FIG. 3 shows a cross-sectional illustration of an optical lens according to a third embodiment of the invention. As shown in FIG. 3, in this embodiment, the optical lens 10c includes a first lens L1, a second lens L2, a third lens L3, a fourth lens L4, a fifth lens L5, an aperture stop 14, a sixth lens L6, a seventh lens L7, an eighth lens L8, a ninth lens L9 and a tenth lens L10. In this embodiment, the first lens L1, the second lens L2, the third lens L3, the fourth lens L4 and the fifth lens L5 form a first lens group 20 with a negative refractive power, the sixth lens L6, the seventh lens L7, the eighth lens L8, the ninth lens L9 and the tenth lens L10 form a second lens group 30 with a positive refractive power, and the first lens L1 to the tenth lens L10 have negative, negative, negative, positive, negative, positive, negative, negative, positive and positive refractive powers, respectively. In this embodiment, all lenses L1-L10 are glass lenses. In other embodiment, at least one glass lens may be replaced with a plastic lens. In this embodiment, the third lens L3 and the tenth lens L10 are aspheric lenses. In this embodiment, the fourth lens L4 and the fifth lens L5 form a cemented doublet, the sixth lens L6 and the seventh lens L7 form a cemented doublet, and the eighth lens L8 and the ninth lens L9 form a cemented doublet, but the invention is not limited thereto. In this embodiment, the first lens L1 (closest to the magnified side among all lenses of the optical lens) has a diameter D1 of 19.4 mm, and the tenth lens L10 (closest to the minified side among all lenses of the optical lens) has a diameter DL of 5.58 mm. Detailed optical data, design parameters and aspheric coefficients of the optical lens 10c are shown in Table 5 below.

TABLE 5
D1 = 19.4 mm; DL = 5.58 mm; D1/DL = 3.5; F# = 2.0

| | Radius | Interval | Refractive | Abbe | Object |
|---|---|---|---|---|---|
| Surface | (mm) | (mm) | index | number | description |
| 1 | 17.13 | 1.15 | 1.77 | 49.60 | meniscus(L1) |
| 2 | 6.30 | 3.31 | | | |
| 3 | 20.07 | 0.60 | 1.77 | 49.60 | meniscus(L2) |
| 4 | 3.80 | 2.48 | | | |
| 5* | −283.03 | 1.52 | 1.69 | 52.80 | aspheric(L3) |
| 6* | 3.80 | 1.88 | | | |
| 7 | 18.81 | 3.12 | 2.00 | 25.5 | biconvex(L4) |
| 8 | −4.88 | 0.55 | 1.99 | 16.50 | meniscus(L5) |
| 9 | −7.80 | 4.40 | | | |
| 10 | inf. | 0.08 | | | aperture stop14 |
| 11 | 57.64 | 1.08 | 1.50 | 81.5 | biconvex(L6) |
| 12 | −3.29 | 0.59 | 1.81 | 40.90 | meniscus(L7) |
| 13 | −6.07 | 0.10 | | | |
| 14 | 14.90 | 0.55 | 1.85 | 24.80 | meniscus(L8) |
| 15 | 3.87 | 1.99 | 1.46 | 90.30 | biconvex(L9) |
| 16 | −12.02 | 0.12 | | | |
| 17* | 6.86 | 2.36 | 1.50 | 81.5 | aspheric(L10) |
| 18* | −5.03 | 0.10 | | | |
| 19 | inf. | 0.30 | 1.52 | 64.1 | optical filter 16 |
| 20 | inf. | 2.90 | | | |
| 21 | inf. | 0.50 | 1.52 | 64.1 | cover glass17 |
| 22 | inf. | 0.10 | | | |
| 23 | | | | | image plane19 |

In the above Table 5, an interval of the surface S1 is a distance between the surface S1 and the surface S2 along the optical axis 12, an interval of the surface S2 is a distance between the surface S2 and the surface S3 along the optical axis 12, and an interval of the surface S22 is a distance between the surface S22 and the image plane 19 along the optical axis 12. Table 6 lists aspheric coefficients and conic constant of each aspheric surface of the optical lens 10c according to the third embodiment of the invention.

TABLE 6

| Surface | K | A | B | C | D | E | F |
|---|---|---|---|---|---|---|---|
| S5 | 0 | 8.00E−03 | −1.00E−03 | 8.29E−05 | −5.07E−06 | 1.79E−07 | −2.64E−09 |
| S6 | 0 | 7.20E−03 | −1.30E−03 | 2.12E−05 | 2.85E−06 | −1.82E−07 | — |
| S17 | 0 | −6.09E−04 | 3.38E−05 | −1.63E−05 | 1.69E−06 | — | — |
| S18 | 0 | 2.43E−03 | −6.33E−05 | −1.23E−05 | 1.47E−06 | — | — |

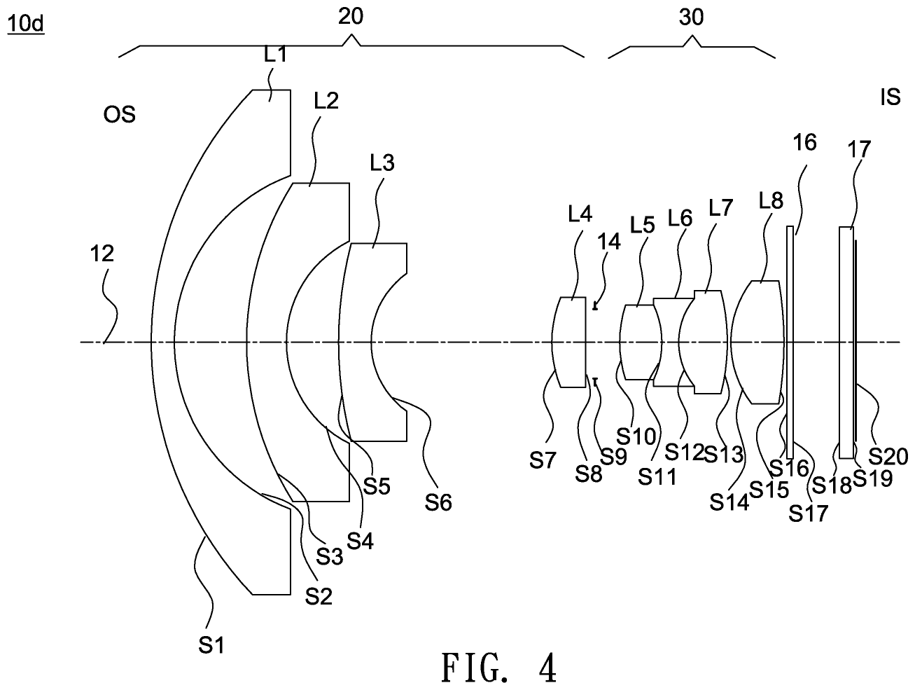

FIG. 4 shows a cross-sectional illustration of an optical lens according to a fourth embodiment of the invention. As shown in FIG. 4, in this embodiment, the optical lens 10d includes a first lens L1, a second lens L2, a third lens L3, a fourth lens L4, an aperture stop 14, a fifth lens L5, a sixth lens L6, a seventh lens L7 and an eighth lens L8. In this embodiment, the first lens L1, the second lens L2, the third lens L3 and the fourth lens L4 form a first lens group 20 with a negative refractive power, the fifth lens L5, the sixth lens L6, the seventh lens L7 and the eighth lens L8 form a second lens group 30 with a positive refractive power, and the first lens L1 to the eighth lens L8 have negative, negative, negative, positive, positive, negative, positive and positive refractive powers, respectively. In this embodiment, all lenses L1-L8 are glass lenses. In other embodiment, at least one glass lens may be replaced with a plastic lens. In this embodiment, the second lens L2 and the eighth lens L8 are aspheric lenses, and the fifth lens L5, the sixth lens L6 and the seventh lens L7 are fit together to form a cemented triplet, but the invention is not limited thereto. In this embodiment, the first lens L1 (closest to the magnified side among all lenses of the optical lens) has a diameter D1 of 21.2 mm, and the eighth lens L8 (closest to the minified side among all lenses of the optical lens) has a diameter DL of 5.32 mm. Detailed optical data, design parameters and aspheric coefficients of the optical lens 10d are shown in Table 7 below.

TABLE 7
D1 = 21.2 mm; DL = 5.32 mm; D1/DL = 4.0; F# = 2.0

| | Radius | Interval | Refractive | Abbe | Object |
|---|---|---|---|---|---|
| Surface | (mm) | (mm) | index | number | description |
| 1 | 16.25 | 1.00 | 1.80 | 46.6 | meniscus(L1) |
| 2 | 7.76 | 3.00 | | | |
| 3* | 25.56 | 1.67 | 1.77 | 50.0 | aspheric(L2) |
| 4* | 5.18 | 2.15 | | | |
| 5 | 18.13 | 1.34 | 1.80 | 46.6 | biconcave(L3) |
| 6 | 3.65 | 7.59 | | | |
| 7 | 6.25 | 1.32 | 1.92 | 20.9 | biconvex(L4) |
| 8 | 90.57 | 0.37 | | | |
| 9 | inf. | 1.06 | | | aperture stop14 |
| 10 | 5.66 | 1.69 | 1.50 | 81.5 | biconvex(L5) |
| 11 | −4.65 | 0.73 | 1.85 | 23.8 | biconcave(L6) |
| 12 | 3.17 | 2.06 | 1.60 | 67.7 | biconvex(L7) |
| 13 | −9.83 | 0.10 | | | |
| 14* | 3.95 | 2.22 | 1.50 | 81.5 | aspheric(L8) |
| 15* | −31.11 | 0.10 | | | |
| 16 | inf. | 0.20 | 1.52 | 64.1 | optical filter 16 |
| 17 | inf. | 2.65 | | | |
| 18 | inf. | 0.50 | 1.52 | 64.1 | cover glass17 |
| 19 | inf. | 0.05 | | | |
| 20 | | | | | image plane19 |

In the above Table 7, an interval of the surface S1 is a distance between the surface S1 and the surface S2 along the optical axis 12, an interval of the surface S2 is a distance between the surface S2 and the surface S3 along the optical axis 12, and an interval of the surface S19 is a distance between the surface S19 and the image plane 19 along the optical axis 12. Table 8 lists aspheric coefficients and conic constant of each aspheric surface of the optical lens 10d according to the fourth embodiment of the invention.

TABLE 8

| Surface | K | A | B | C | D | E |
|---|---|---|---|---|---|---|
| S3 | −5.79 | 1.65E−03 | −5.21E−05 | 8.67E−07 | −7.69E−09 | 2.73E−11 |
| S4 | −0.12 | 1.88E−03 | 7.89E−05 | −1.69E−05 | 7.07E−07 | −1.19E−08 |
| S14 | −0.47 | −1.40E−03 | −2.20E−05 | −2.43E−06 | −8.24E−07 | — |
| S15 | 0.00 | 6.08E−04 | −1.83E−04 | −1.21E−05 | 2.51E−07 | — |

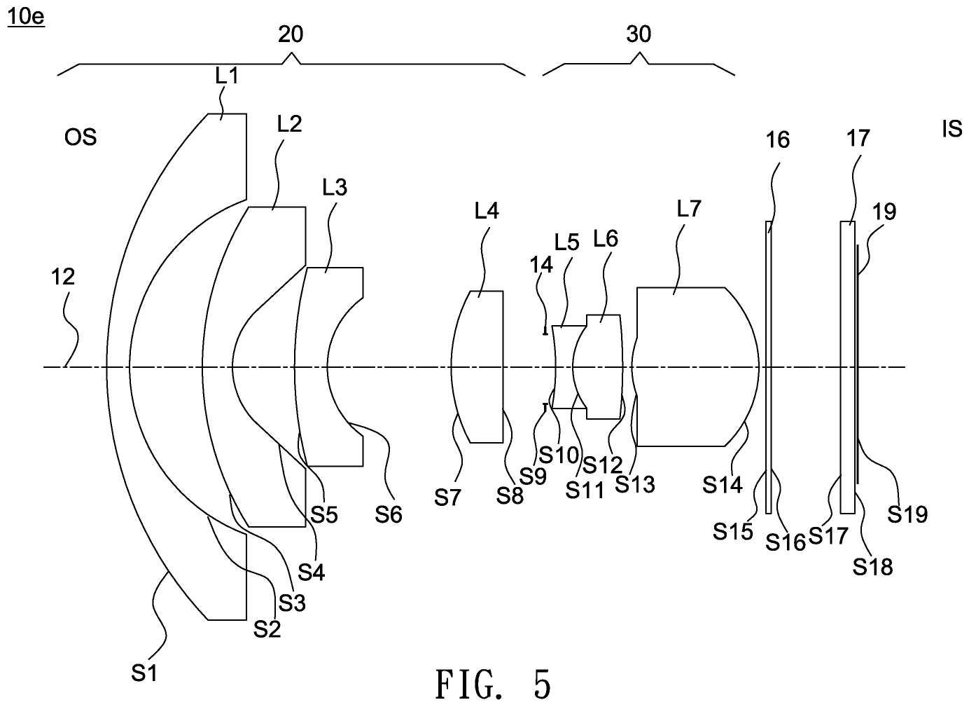

FIG. 5 shows a cross-sectional illustration of an optical lens according to a fifth embodiment of the invention. As shown in FIG. 5, in this embodiment, the optical lens 10e includes a first lens L1, a second lens L2, a third lens L3, a fourth lens L4, an aperture stop 14, a fifth lens L5, a sixth lens L6 and a seventh lens L7. In this embodiment, the first lens L1, the second lens L2, the third lens L3 and the fourth lens L4 form a first lens group 20 with a negative refractive power, the fifth lens L5, the sixth lens L6 and the seventh lens L7 form a second lens group 30 with a positive refractive power, and the first lens L1 to the seventh lens L7 have negative, negative, negative, positive, negative, positive and positive refractive powers, respectively. In this embodiment, all lenses L1-L7 are glass lenses. In other embodiment, at least one glass lens may be replaced with a plastic lens. In this embodiment, the second lens L2 and the seventh lens L7 are aspheric lenses, and the fifth lens L5 and the sixth lens L6 form a cemented doublet, but the invention is not limited thereto. In this embodiment, the first lens L1 (closest to the magnified side among all lenses of the optical lens) has a diameter D1 of 23 mm, and the seventh lens L7 (closest to the minified side among all lenses of the optical lens) has a diameter DL of 5.27 mm. Detailed optical data, design parameters and aspheric coefficients of the optical lens 10e are shown in Table 9 below.

TABLE 9
D1 = 23 mm; DL = 5.27 mm; D1/DL = 4.4; F# = 2.0

| | Radius | Interval | Refractive | Abbe | Object |
|---|---|---|---|---|---|
| Surface | (mm) | (mm) | index | number | description |
| 1 | 19.65 | 1.76 | 1.80 | 46.5 | meniscus(L1) |
| 2 | 7.37 | 2.53 | | | |
| 3* | 8.81 | 1.34 | 1.77 | 50.0 | aspheric(L2) |
| 4* | 3.08 | 2.63 | | | |
| 5 | 14.85 | 0.60 | 1.54 | 74.7 | biconcave(L3) |
| 6 | 3.71 | 7.35 | | | |
| 7 | 6.14 | 1.64 | 2.00 | 19.3 | biconvex(L4) |
| 8 | inf. | 1.66 | | | |
| 9 | inf. | 0.15 | | | aperture stop14 |
| 10 | −12.92 | 0.60 | 1.92 | 18.9 | biconcave(L5) |
| 11 | 2.60 | 1.67 | 1.80 | 46.5 | biconvex(L6) |
| 12 | −8.38 | 0.10 | | | |
| 13* | 9.03 | 4.17 | 1.52 | 64.1 | aspheric(L7) |
| 14* | −3.59 | 0.10 | | | |
| 15 | inf. | 0.21 | 1.52 | 64.1 | optical filter 16 |
| 16 | inf. | 2.31 | | | |
| 17 | inf. | 0.40 | 1.52 | 64.1 | cover glass 17 |
| 18 | inf. | 0.03 | | | |
| 19 | | | | | image plane 19 |

In the above Table 9, an interval of the surface S1 is a distance between the surface S1 and the surface S2 along the optical axis 12, an interval of the surface S2 is a distance between the surface S2 and the surface S3 along the optical axis 12, and an interval of the surface S18 is a distance between the surface S18 and the image plane 19 along the optical axis 12. Table 10 lists aspheric coefficients and conic constant of each aspheric surface of the optical lens 10e according to the fifth embodiment of the invention.

TABLE 10

| Surface | K | A | B | C | D | E |
|---|---|---|---|---|---|---|
| S3 | 0.04 | 1.89E−04 | −3.20E−05 | 4.76E−07 | −1.83E−09 | −2.28E−11 |
| S4 | −2.52 | 7.97E−03 | −3.56E−04 | 7.02E−06 | −1.06E−07 | −2.67E−19 |
| S13 | 0.40 | −5.73E−03 | −4.47E−04 | 4.88E−05 | −2.57E−05 | — |
| S14 | −2.84 | −6.29E−03 | 4.46E−05 | −9.10E−06 | −8.11E−07 | — |

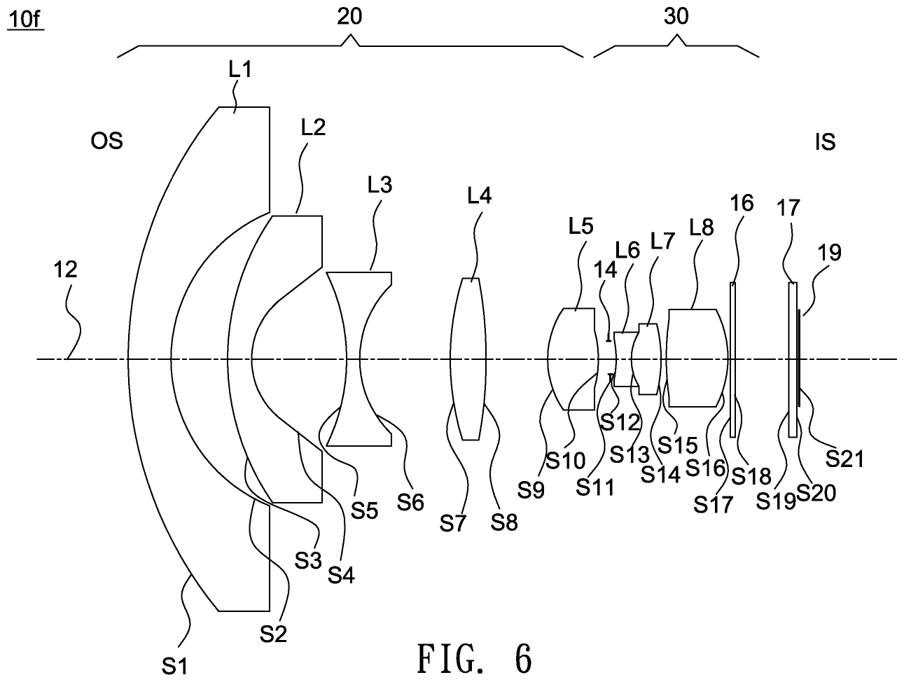

FIG. 6 shows a cross-sectional illustration of an optical lens according to a sixth embodiment of the invention. As shown in FIG. 6, in this embodiment, the optical lens 10f includes a first lens L1, a second lens L2, a third lens L3, a fourth lens L4, a fifth lens L5, an aperture stop 14, a sixth lens L6, a seventh lens L7 and an eighth lens L8. In this embodiment, the first lens L1, the second lens L2, the third lens L3, the fourth lens L4 and the fifth lens L5 form a first lens group 20 with a negative refractive power, the sixth lens L6, the seventh lens L7 and the eighth lens L8 form a second lens group 30 with a positive refractive power, and the first lens L1 to the eighth lens L8 have negative, negative, negative, positive, positive, negative, positive and positive refractive powers, respectively. In this embodiment, all lenses L1-L8 are glass lenses. In other embodiment, at least one glass lens may be replaced with a plastic lens. In this embodiment, the second lens L2 and the eighth lens L8 are aspheric lenses, and the sixth lens L6 and the seventh lens L7 are fit together to form a cemented doublet, but the invention is not limited thereto. In this embodiment, the first lens L1 (closest to the magnified side among all lenses of the optical lens) has a diameter D1 of 23 mm, and the eighth lens L8 (closest to the minified side among all lenses of the optical lens) has a diameter DL of 4.52mm. Detailed optical data, design parameters and aspheric coefficients of the optical lens 10f are shown in Table 11 below.

TABLE 11
D1 = 23 mm; DL = 4.52 mm; D1/DL = 5.1; F# = 2.0

| | Radius | Interval | Refractive | Abbe | Object |
|---|---|---|---|---|---|
| Surface | (mm) | (mm) | index | number | description |
| 1 | 18.67 | 1.84 | 1.80 | 46.5 | meniscus(L1) |
| 2 | 7.35 | 2.55 | | | |
| 3* | 9.09 | 1.23 | 1.77 | 50.0 | aspheric(L2) |
| 4* | 3.17 | 3.90 | | | |
| 5 | −9.35 | 0.60 | 1.50 | 81.5 | biconcave(L3) |
| 6 | 4.66 | 4.04 | | | |
| 7 | 15.57 | 1.52 | 2.00 | 29.10 | biconvex(L4) |
| 8 | −19.07 | 2.70 | | | |
| 9 | 4.31 | 2.13 | 1.50 | 81.5 | biconvex(L5) |
| 10 | −16.15 | 0.72 | | | |
| 11 | inf. | 0.21 | | | aperture stop14 |
| 12 | −5.75 | 0.60 | 1.76 | 26.50 | biconcave(L6) |
| 13 | 2.69 | 1.34 | 1.60 | 65.40 | biconvex(L7) |
| 14 | −6.77 | 0.10 | | | |
| 15* | 8.86 | 2.75 | 1.74 | 49.00 | aspheric(L8) |
| 16* | −5.91 | 0.10 | | | |
| 17 | inf. | 0.21 | 1.52 | 64.1 | optical filter 16 |
| 18 | inf. | 2.29 | | | |
| 19 | inf. | 0.40 | 1.52 | 64.1 | cover glass 17 |
| 20 | inf. | 0.05 | | | |
| 21 | | | | | image plane 19 |

In the above Table 11, an interval of the surface S1 is a distance between the surface S1 and the surface S2 along the optical axis 12, an interval of the surface S2 is a distance between the surface S2 and the surface S3 along the optical axis 12, and an interval of the surface S20 is a distance between the surface S20 and the image plane 19 along the optical axis 12. Table 12 lists aspheric coefficients and conic constant of each aspheric surface of the optical lens 10f according to the sixth embodiment of the invention.

TABLE 12

| Surface | K | A | B | C | D | E |
|---|---|---|---|---|---|---|
| S3 | 0.59 | −2.46E−05 | −3.13E−05 | 4.22E−07 | 1.42E−09 | −7.97E−11 |
| S4 | −2.88 | 8.33E−03 | −4.29E−04 | 1.22E−05 | −1.96E−07 | −1.59E−18 |
| S15 | 13.08 | −6.47E−03 | −4.47E−04 | 4.88E−05 | −2.57E−05 | — |
| S16 | −7.16 | −5.67E−03 | 4.46E−05 | −9.10E−06 | −8.11E−07 | — |

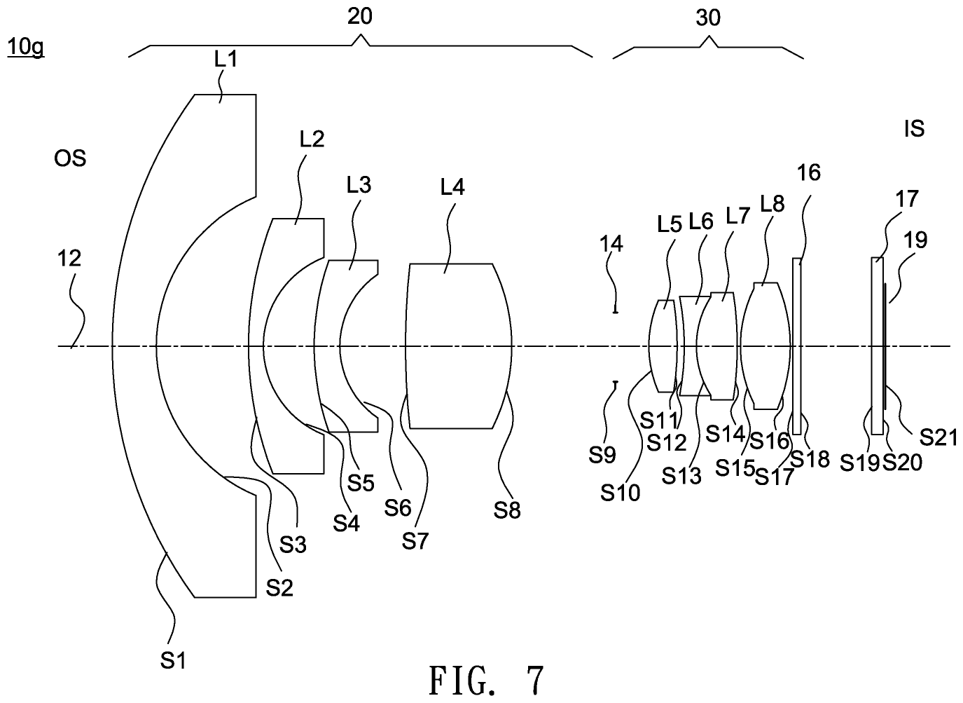

FIG. 7 shows a cross-sectional illustration of an optical lens according to a seventh embodiment of the invention. As shown in FIG. 7, in this embodiment, the optical lens 10g includes a first lens L1, a second lens L2, a third lens L3, a fourth lens L4, an aperture stop 14, a fifth lens L5, a sixth lens L6, a seventh lens L7 and an eighth lens L8. In this embodiment, the first lens L1, the second lens L2, the third lens L3 and the fourth lens L4 form a first lens group 20 with a negative refractive power, the fifth lens L5, the sixth lens L6, the seventh lens L7 and the eighth lens L8 form a second lens group 30 with a positive refractive power, and the first lens L1 to the eighth lens L8 have negative, negative, negative, positive, positive, negative, positive and positive refractive powers, respectively. In this embodiment, all lenses L1-L8 are glass lenses. In other embodiment, at least one glass lens may be replaced with a plastic lens. In this embodiment, the third lens L3 and the eighth lens L8 are aspheric lenses, and the sixth lens L6 and the seventh lens L7 are fit together to form a cemented doublet, but the invention is not limited thereto. In this embodiment, the first lens L1 (closest to the magnified side among all lenses of the optical lens) has a diameter D1 of 20.1 mm, and the eighth lens L8 (closest to the minified side among all lenses of the optical lens) has a diameter DL of 5.2mm. Detailed optical data, design parameters and aspheric coefficients of the optical lens 10g are shown in Table 13 below.

TABLE 13
D1 = 20.1 mm; DL = 5.2 mm; D1/DL = 3.9; F# = 2.0

| | Radius | Interval | Refractive | Abbe | Object |
|---|---|---|---|---|---|
| Surface | (mm) | (mm) | index | number | description |
| 1 | 17.38 | 1.74 | 2.00 | 25.5 | meniscus(L1) |
| 2 | 6.61 | 3.60 | | | |
| 3 | 16.11 | 0.58 | 1.59 | 68.6 | meniscus(L2) |
| 4 | 3.86 | 1.88 | | | |
| 5* | 30.96 | 1.04 | 1.77 | 50.0 | aspheric(L3) |
| 6* | 3.66 | 2.60 | | | |
| 7 | 74.69 | 4.00 | 2.05 | 16.9 | biconvex(L4) |
| 8 | −8.15 | 3.95 | | | |
| 9 | inf. | 1.38 | | | aperture stop14 |
| 10 | 5.75 | 1.10 | 1.50 | 81.5 | biconvex(L5) |
| 11 | −8.51 | 0.20 | | | |
| 12 | −14.46 | 0.45 | 1.81 | 25.4 | biconcave(L6) |
| 13 | 3.70 | 1.61 | 1.55 | 75.7 | biconvex(L7) |
| 14 | −19.46 | 0.10 | | | |
| 15* | 4.76 | 1.97 | 1.50 | 81.5 | aspheric(L8) |
| 16* | −7.68 | 0.10 | | | |
| 17 | inf. | 0.30 | 1.52 | 64.1 | optical filter 16 |
| 18 | inf. | 2.76 | | | |
| 19 | inf. | 0.40 | 1.52 | 64.1 | cover glass 17 |
| 20 | inf. | 0.05 | | | |
| 21 | | | | | image plane 19 |

In the above Table 13, an interval of the surface S1 is a distance between the surface S1 and the surface S2 along the optical axis 12, an interval of the surface S2 is a distance between the surface S2 and the surface S3 along the optical axis 12, and an interval of the surface S20 is a distance between the surface S20 and the image plane 19 along the optical axis 12. Table 14 lists aspheric coefficients and conic constant of each aspheric surface of the optical lens 10g according to the seventh embodiment of the invention.

TABLE 14

| Surface | K | A | B | C | D | E |
|---|---|---|---|---|---|---|
| S5 | 0 | 1.40E−02 | −2.82E−03 | 4.39E−04 | −5.27E−05 | 3.96E−06 |
| S6 | 0 | 1.62E−02 | −3.80E−03 | 6.75E−04 | −1.45E−04 | 2.01E−05 |
| S15 | 0 | −2.11E−03 | −9.42E−05 | −1.43E−04 | 6.49E−05 | −1.65E−05 |
| S16 | 0 | 2.12E−03 | −4.12E−04 | −5.98E−05 | 3.11E−05 | −7.70E−06 |

| Surface | F | G |
|---|---|---|
| S5 | −1.60E−07 | 2.60E−09 |
| S6 | −1.45E−06 | 4.18E−08 |
| S15 | 1.95E−06 | −9.58E−08 |
| S16 | 8.10E−07 | −3.42E−08 |

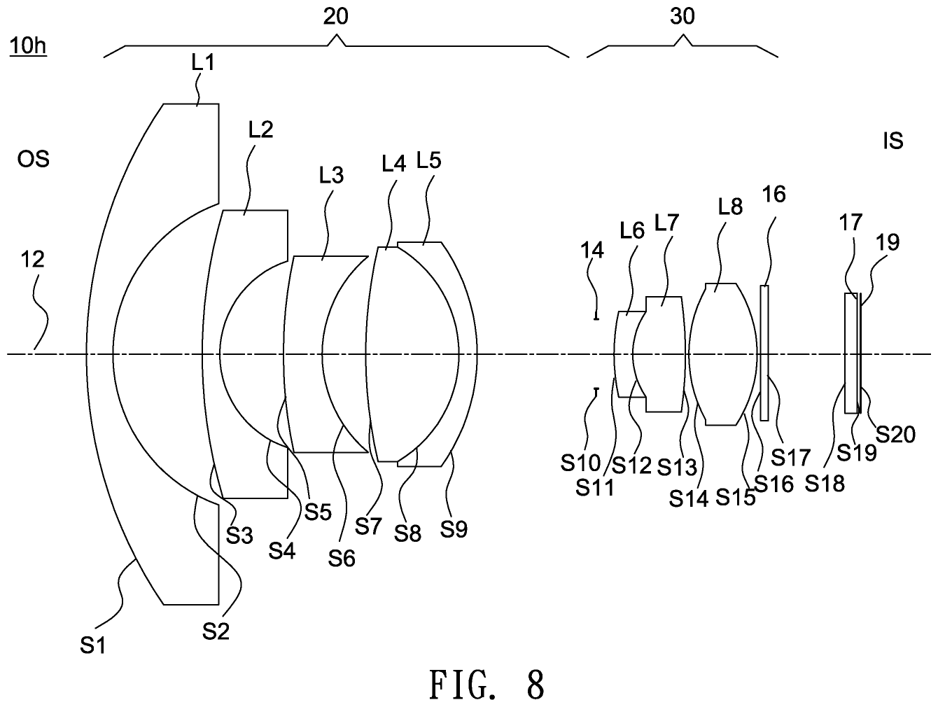

FIG. 8 shows a cross-sectional illustration of an optical lens according to an eighth embodiment of the invention. As shown in FIG. 8, in this embodiment, the optical lens 10h includes a first lens L1, a second lens L2, a third lens L3, a fourth lens L4, a fifth lens L5, an aperture stop 14, a sixth lens L6, a seventh lens L7 and an eighth lens L8. In this embodiment, the first lens L1, the second lens L2, the third lens L3, the fourth lens L4 and the fifth lens L5 form a first lens group 20 with a negative refractive power, the sixth lens L6, the seventh lens L7 and the eighth lens L8 form a second lens group 30 with a positive refractive power, and the first lens L1 to the eighth lens L8 have negative, negative, negative, positive, negative, negative, positive and positive refractive powers, respectively. In this embodiment, all lenses L1-L8 are glass lenses. In other embodiment, at least one glass lens may be replaced with a plastic lens. In this embodiment, the third lens L3 and the eighth lens L8 are aspheric lenses, the fourth lens L4 and the fifth lens L5 form a cemented doublet, and the sixth lens L6 and the seventh lens L7 form a cemented doublet, but the invention is not limited thereto. In this embodiment, the first lens L1 (closest to the magnified side among all lenses of the optical lens) has a diameter D1 of 20.1 mm, and the eighth lens L8 (closest to the minified side among all lenses of the optical lens) has a diameter DL of 5.2 mm. Detailed optical data, design parameters and aspheric coefficients of the optical lens 10h are shown in Table 15 below.

TABLE 15
D1 = 20.1 mm; DL = 5.2 mm; D1/DL = 3.9; F# = 2.0

| | Radius | Interval | Refractive | Abbe | Object |
|---|---|---|---|---|---|
| Surface | (mm) | (mm) | index | number | description |
| 1 | 17.76 | 1.10 | 1.77 | 49.60 | meniscus(L1) |
| 2 | 6.43 | 3.43 | | | |
| 3 | 22.40 | 0.62 | 1.77 | 49.60 | meniscus(L2) |
| 4 | 3.90 | 2.46 | | | |
| 5* | −109.98 | 1.54 | 1.69 | 52.80 | aspheric(L3) |
| 6* | 4.29 | 1.69 | | | |
| 7 | 20.16 | 3.55 | 2.00 | 25.5 | biconvex(L4) |
| 8 | −4.85 | 0.70 | 1.99 | 16.50 | meniscus(L5) |
| 9 | −7.86 | 4.61 | | | |
| 10 | inf. | 0.66 | | | aperture stop14 |
| 11 | 8.77 | 0.76 | 1.95 | 18.00 | biconcave(L6) |
| 12 | 3.71 | 2.00 | 1.46 | 90.30 | biconvex(L7) |
| 13 | −12.89 | 0.12 | | | |
| 14* | 5.71 | 2.65 | 1.50 | 81.5 | aspheric(L8) |
| 15* | −4.18 | 0.10 | | | |
| 16 | inf. | 0.30 | 1.52 | 64.1 | optical filter 16 |
| 17 | inf. | 2.90 | | | |
| 18 | inf. | 0.50 | 1.52 | 64.1 | cover glass 17 |
| 19 | inf. | 0.10 | | | |
| 20 | | | | | image plane 19 |

In the above Table 15, an interval of the surface S1 is a distance between the surface S1 and the surface S2 along the optical axis 12, an interval of the surface S2 is a distance between the surface S2 and the surface S3 along the optical axis 12, and an interval of the surface S19 is a distance between the surface S19 and the image plane 19 along the optical axis 12. Table 16 lists aspheric coefficients and conic constant of each aspheric surface of the optical lens 10h according to the eighth embodiment of the invention.

TABLE 16

| Surface | K | A | B | C | D | E | F |
|---|---|---|---|---|---|---|---|
| S5 | 0 | 9.22E−03 | −1.11E−03 | 8.95E−05 | −5.30E−06 | 1.75E−07 | −2.33E−09 |
| S6 | 0 | 9.12E−03 | −1.35E−03 | 4.18E−05 | 3.02E−07 | −3.31E−08 | −7.04E−10 |
| S14 | 0 | −1.74E−03 | 1.08E−04 | −2.95E−05 | 4.04E−06 | −1.49E−07 | — |
| S15 | 0 | 3.87E−03 | −1.54E−04 | 1.74E−05 | −1.85E−06 | 1.74E−07 | — |

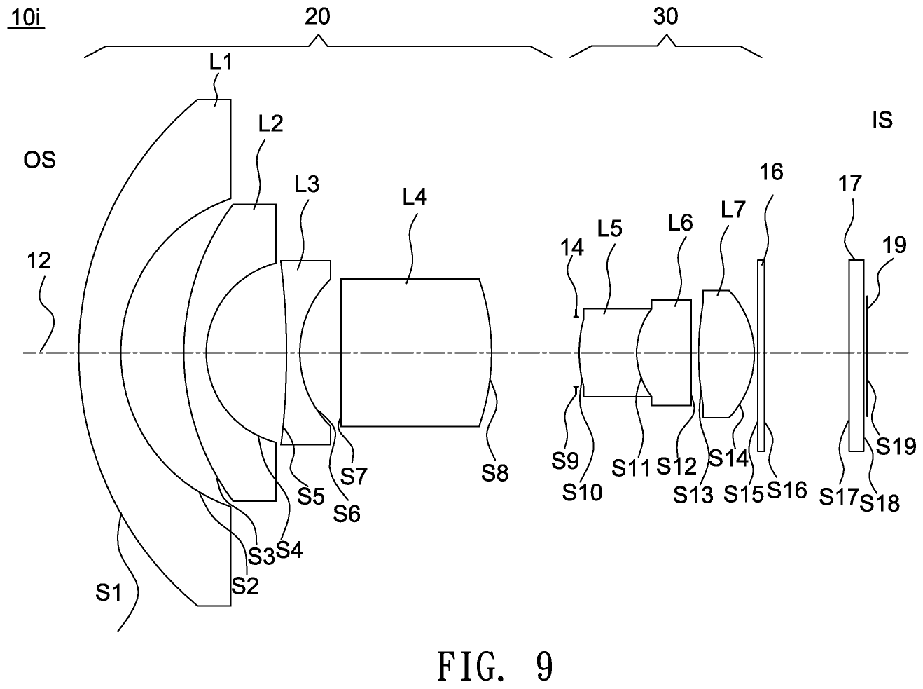

FIG. 9 shows a cross-sectional illustration of an optical lens according to a ninth embodiment of the invention. As shown in FIG. 9, in this embodiment, the optical lens 10i includes a first lens L1, a second lens L2, a third lens L3, a fourth lens L4, an aperture stop 14, a fifth lens L5, a sixth lens L6 and a seventh lens L7. In this embodiment, the first lens L1, the second lens L2, the third lens L3 and the fourth lens L4 form a first lens group 20 with a negative refractive power, the fifth lens L5, the sixth lens L6 and the seventh lens L7 form a second lens group 30 with a positive refractive power, and the first lens L1 to the seventh lens L7 have negative, negative, negative, positive, negative, positive and positive refractive powers, respectively. In this embodiment, all lenses L1-L7 are glass lenses. In other embodiment, at least one glass lens may be replaced with a plastic lens. In this embodiment, the seventh lens L7 is an aspheric lens, and the fifth lens L5 and the sixth lens L6 form a cemented doublet, but the invention is not limited thereto. In this embodiment, the first lens L1 (closest to the magnified side among all lenses of the optical lens) has a diameter D1 of 18.7 mm, and the seventh lens L7 (closest to the minified side among all lenses of the optical lens) has a diameter DL of 4.7 mm. Detailed optical data, design parameters and aspheric coefficients of the optical lens 10i are shown in Table 17 below.

TABLE 17
D1 = 18.7 mm; DL = 4.7 mm; D1/DL = 4.0; F# = 2.0

| | Radius | Interval | Refractive | Abbe | Object |
|---|---|---|---|---|---|
| Surface | (mm) | (mm) | index | number | description |
| 1 | 12.37 | 1.50 | 1.87 | 40.70 | meniscus(L1) |
| 2 | 6.09 | 2.24 | | | |
| 3 | 9.35 | 0.80 | 1.83 | 42.70 | meniscus(L2) |
| 4 | 3.50 | 2.52 | | | |
| 5 | −28.46 | 0.60 | 1.70 | 55.50 | biconcave(L3) |
| 6 | 4.04 | 1.49 | | | |
| 7 | inf. | 5.34 | 2.00 | 25.5 | plano-convex (L4) |
| 8 | −8.22 | 3.25 | | | |
| 9 | inf. | 0.05 | | | aperture stop14 |
| 10 | 7.13 | 2.04 | 1.99 | 16.50 | meniscus(L5) |
| 11 | 2.94 | 1.90 | 1.70 | 55.50 | biconvex(L6) |
| 12 | 427.47 | 0.10 | | | |
| 13* | 7.95 | 2.07 | 1.50 | 81.5 | aspheric(L7) |
| 14* | −3.28 | 0.10 | | | |
| 15 | inf. | 0.20 | 1.52 | 64.1 | optical filter 16 |
| 16 | inf. | 3.00 | | | |
| 17 | inf. | 0.50 | 1.52 | 64.1 | cover glass 17 |
| 18 | inf. | 0.10 | | | |
| 19 | | | | | image plane 19 |

In the above Table 17, an interval of the surface S1 is a distance between the surface S1 and the surface S2 along the optical axis 12, an interval of the surface S2 is a distance between the surface S2 and the surface S3 along the optical axis 12, and an interval of the surface S18 is a distance between the surface S18 and the image plane 19 along the optical axis 12. Table 18 lists aspheric coefficients and conic constant of each aspheric surface of the optical lens 10i according to the ninth embodiment of the invention.

TABLE 18

| Surface | K | A | B | C | D | E | E |
|---|---|---|---|---|---|---|---|
| S13 | 0 | −7.65E−03 | 3.53E−05 | 3.79E−05 | −1.70E−05 | 4.78E−07 | — |
| S14 | 0 | 3.40E−03 | −2.06E−03 | 9.24E−04 | −2.34E−04 | 3.10E−05 | −1.76E−06 |

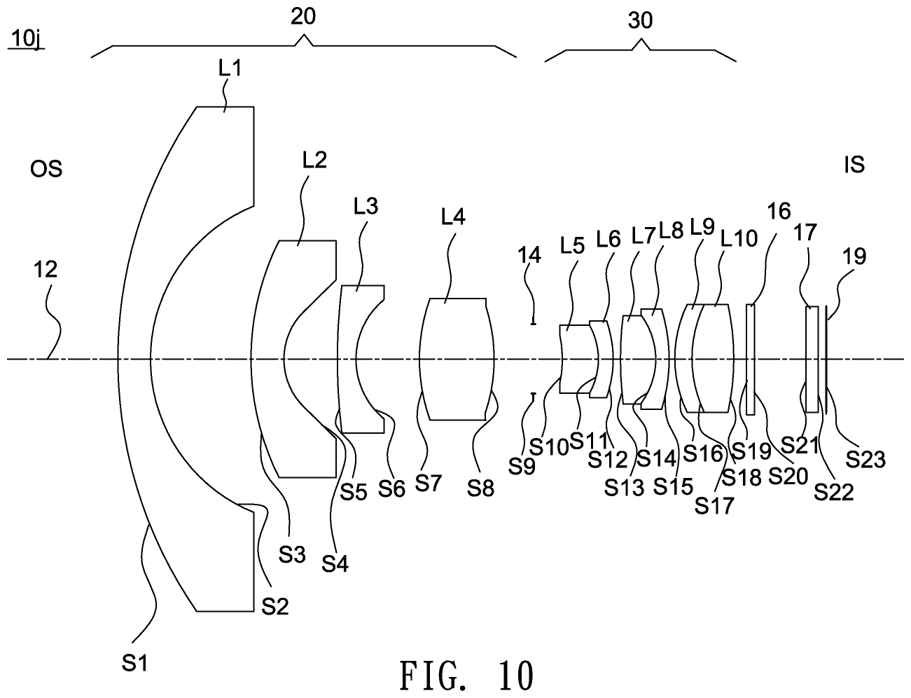

FIG. 10 shows a cross-sectional illustration of an optical lens according to a tenth embodiment of the invention. As shown in FIG. 10, in this embodiment, the optical lens 10j includes a first lens L1, a second lens L2, a third lens L3, a fourth lens L4, an aperture stop 14, a fifth lens L5, a sixth lens L6, a seventh lens L7, an eighth lens L8, a ninth lens L9 and a tenth lens L10. In this embodiment, the first lens L1, the second lens L2, the third lens L3 and the fourth lens L4 form a first lens group 20 with a negative refractive power, the fifth lens L5 the sixth lens L6, the seventh lens L7, the eighth lens L8, the ninth lens L9 and the tenth lens L10 form a second lens group 30 with a positive refractive power, and the first lens L1 to the tenth lens L10 have negative, negative, negative, positive, positive, negative, positive, negative, negative and positive refractive powers, respectively. In this embodiment, all lenses L1-L10 are glass lenses. In other embodiment, at least one glass lens may be replaced with a plastic lens. In this embodiment, the second lens L2 is an aspheric lens. In this embodiment, the fifth lens L5 and the sixth lens L6 form a cemented doublet, the seventh lens L7 and the eighth lens L8 form a cemented doublet, and the ninth lens L9 and the tenth lens L10 form a cemented doublet, but the invention is not limited thereto. In this embodiment, the first lens L1 (closest to the magnified side among all lenses of the optical lens) has a diameter D1 of 22.2 mm, and the tenth lens L10 (closest to the minified side among all lenses of the optical lens) has a diameter DL of 4.9 mm. Detailed optical data, design parameters and aspheric coefficients of the optical lens 10j are shown in Table 19 below.

TABLE 19
D1 = 22.2 mm; DL = 4.9 mm; D1/DL = 4.5; F# = 2.0

| | Radius | Interval | Refractive | Abbe | Object |
|---|---|---|---|---|---|
| Surface | (mm) | (mm) | index | number | description |
| 1 | 19.76 | 1.36 | 1.88 | 40.80 | meniscus(L1) |
| 2 | 7.35 | 4.37 | | | |
| 3* | inf. | 1.38 | 1.80 | 40.70 | aspheric(L2) |
| 4* | 4.27 | 2.39 | | | |
| 5 | 100.75 | 0.65 | 1.50 | 81.5 | meniscus(L3) |
| 6 | 3.62 | 2.72 | | | |
| 7 | 9.34 | 3.00 | 1.85 | 30.10 | biconvex(L4) |
| 8 | −11.91 | 1.83 | | | |
| 9 | inf. | 1.16 | | | aperture stop14 |
| 10 | −21.29 | 1.61 | 1.50 | 81.5 | meniscus(L5) |
| 11 | −2.77 | 0.60 | 1.88 | 39.20 | biconvex(L6) |
| 12 | −4.24 | 0.10 | | | |
| 13 | 20.43 | 1.49 | 1.46 | 90.30 | biconvex(L7) |
| 14 | −3.53 | 0.60 | 1.81 | 25.40 | meniscus(L8) |
| 15 | −7.89 | 0.10 | | | |
| 16 | 6.14 | 0.60 | 1.85 | 23.8 | meniscus(L9) |
| 17 | 3.99 | 1.93 | 1.50 | 81.5 | biconvex(L10) |
| 18 | −8.81 | 0.50 | | | |
| 19 | inf. | 0.30 | 1.52 | 64.1 | optical filter 16 |
| 20 | inf. | 2.20 | | | |
| 21 | inf. | 0.50 | 1.52 | 64.1 | cover glass 17 |
| 22 | inf. | 0.40 | | | |
| 23 | | | | | image plane 19 |

In the above Table 19, an interval of the surface S1 is a distance between the surface S1 and the surface S2 along the optical axis 12, an interval of the surface S2 is a distance between the surface S2 and the surface S3 along the optical axis 12, and an interval of the surface S22 is a distance between the surface S22 and the image plane 19 along the optical axis 12. Table 20 lists aspheric coefficients and conic constant of each aspheric surface of the optical lens 10j according to the tenth embodiment of the invention.

TABLE 20

| Surface | K | A | B | C | D | E |
|---|---|---|---|---|---|---|
| S3 | 0 | 8.68E−03 | −7.81E−04 | 4.43E−05 | −1.74E−06 | 4.51E−08 |
| S4 | −0.83 | 1.31E−02 | 2.06E−04 | −2.90E−04 | 3.58E−05 | −1.88E−06 |

| Surface | F | G |
|---|---|---|
| S3 | −6.69E−10 | 4.13E−12 |
| S4 | 3.30E−08 | 1.42E−10 |

Table 21 lists refractive powers of all lenses of each of the first to the tenth embodiments.

TABLE 21

| | |
|---|---|
| First embodiment | −−−++−++ |
| Second embodiment | −−−++−++ |
| Third embodiment | −−−+−+−−++ |
| Fourth embodiment | −−−++−++ |
| Fifth embodiment | −−−+−++ |
| Sixth embodiment | −−−++−++ |
| Seventh embodiment | −−−++−++ |
| Eighth embodiment | −−−+−−++ |
| Ninth embodiment | −−−+−++ |
| Tenth embodiment | −−−++−+−−+ |

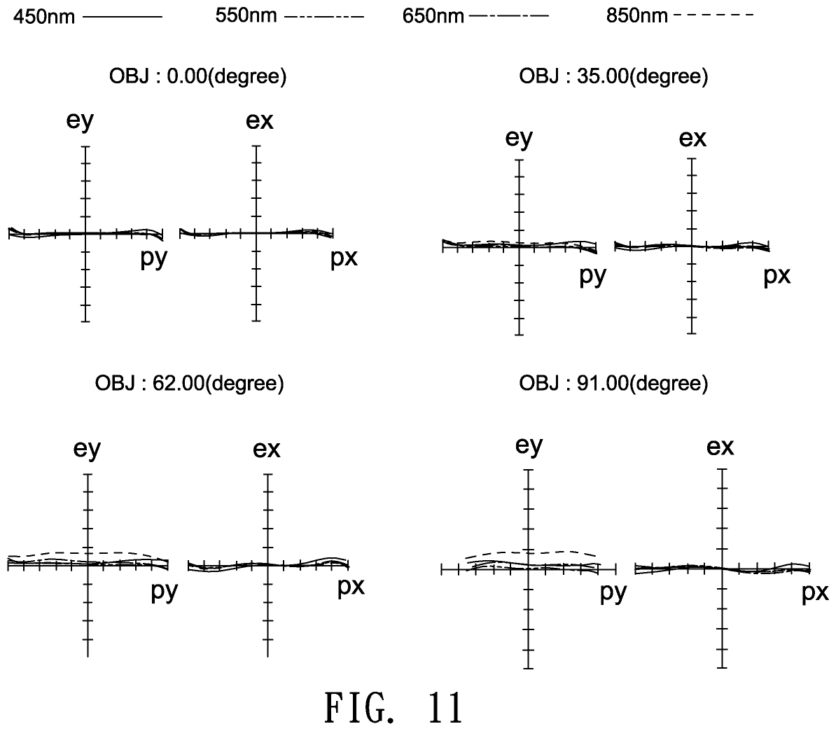

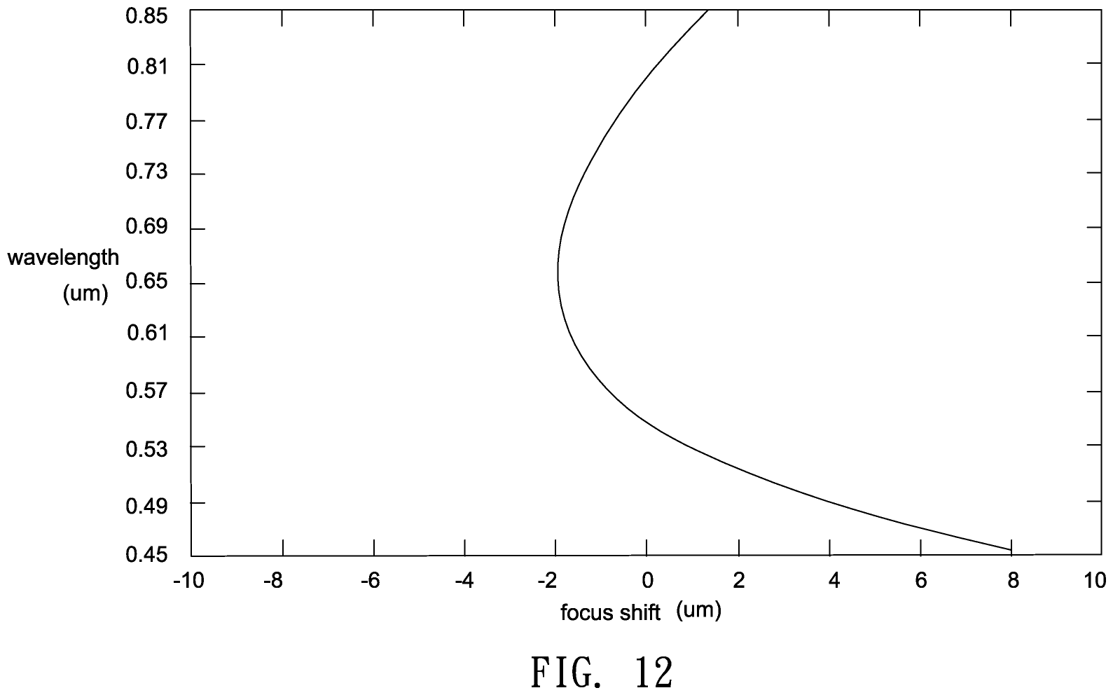

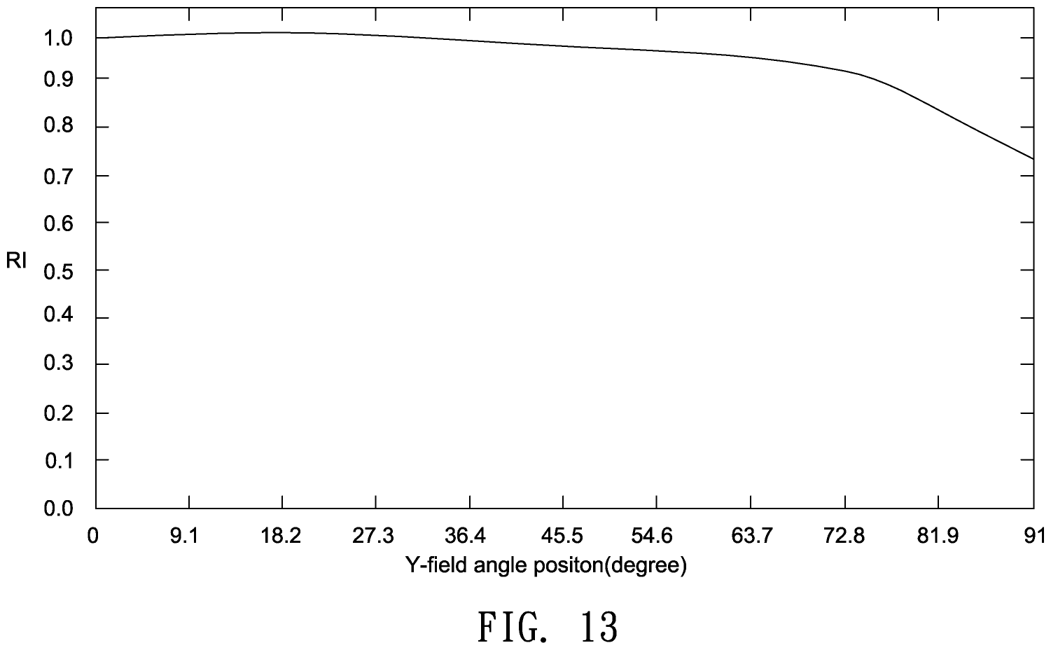

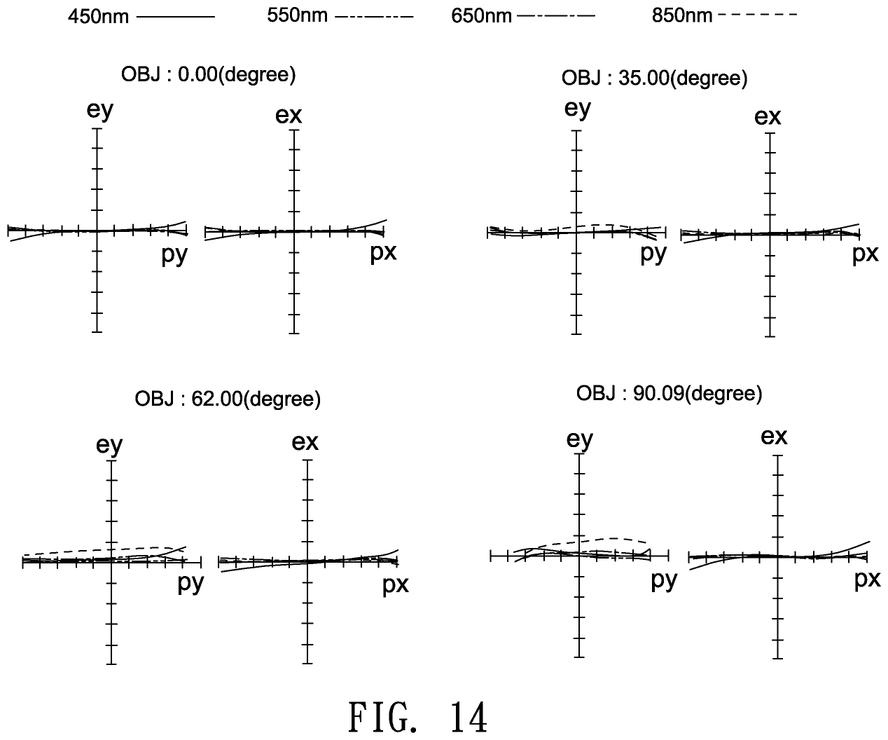

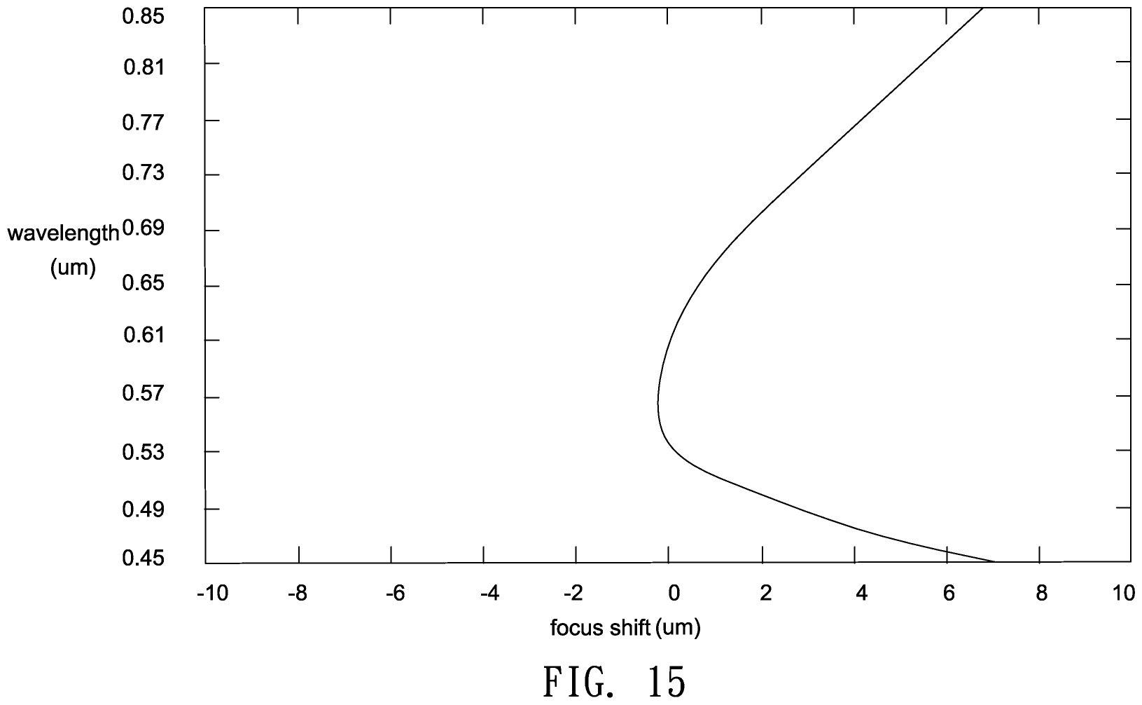

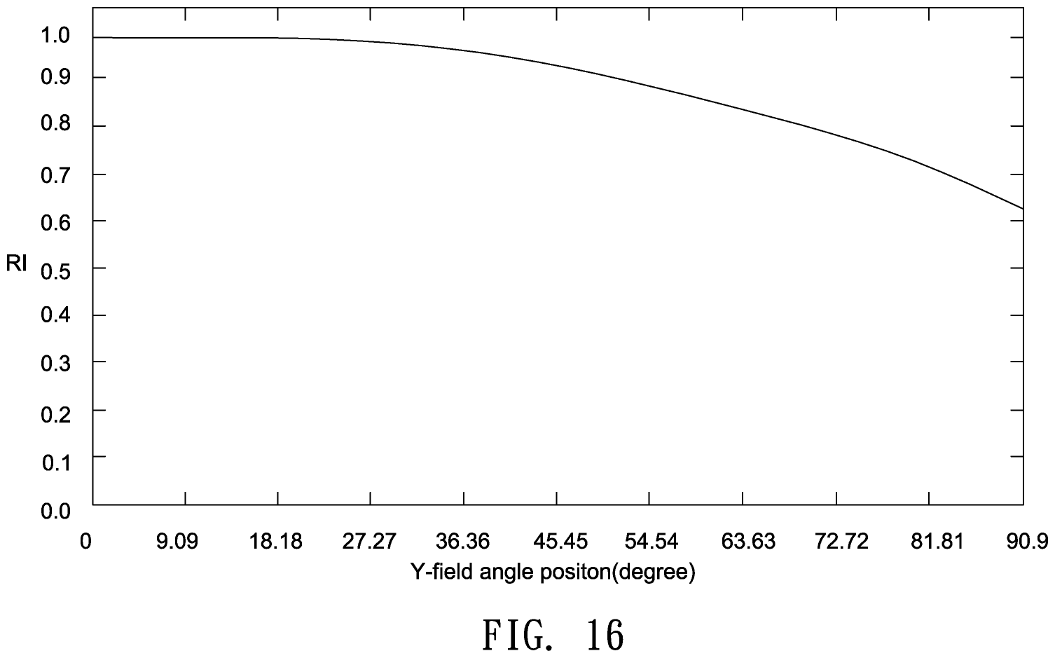

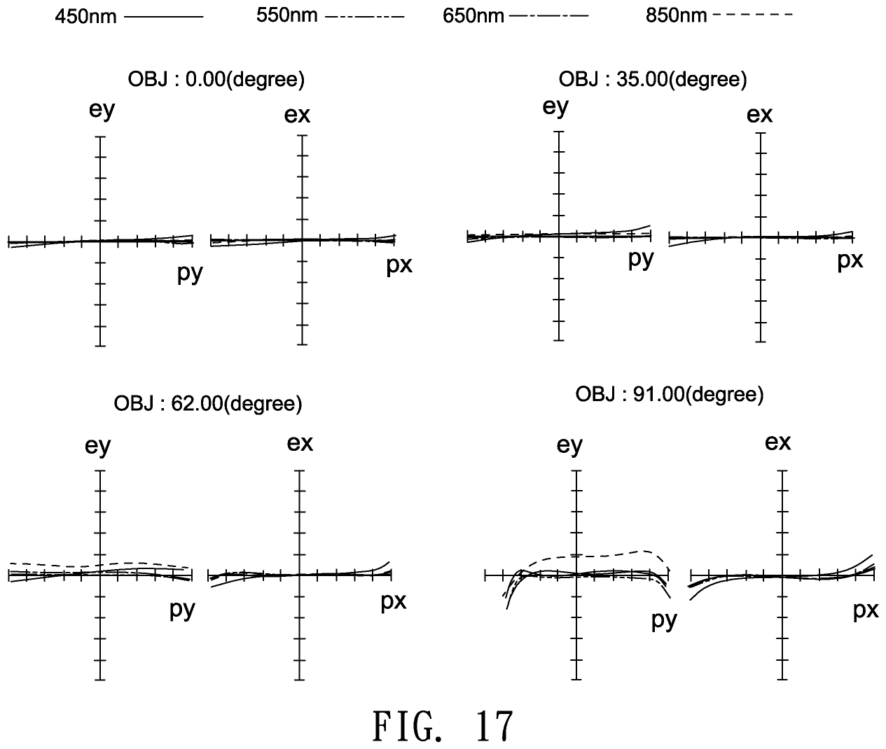

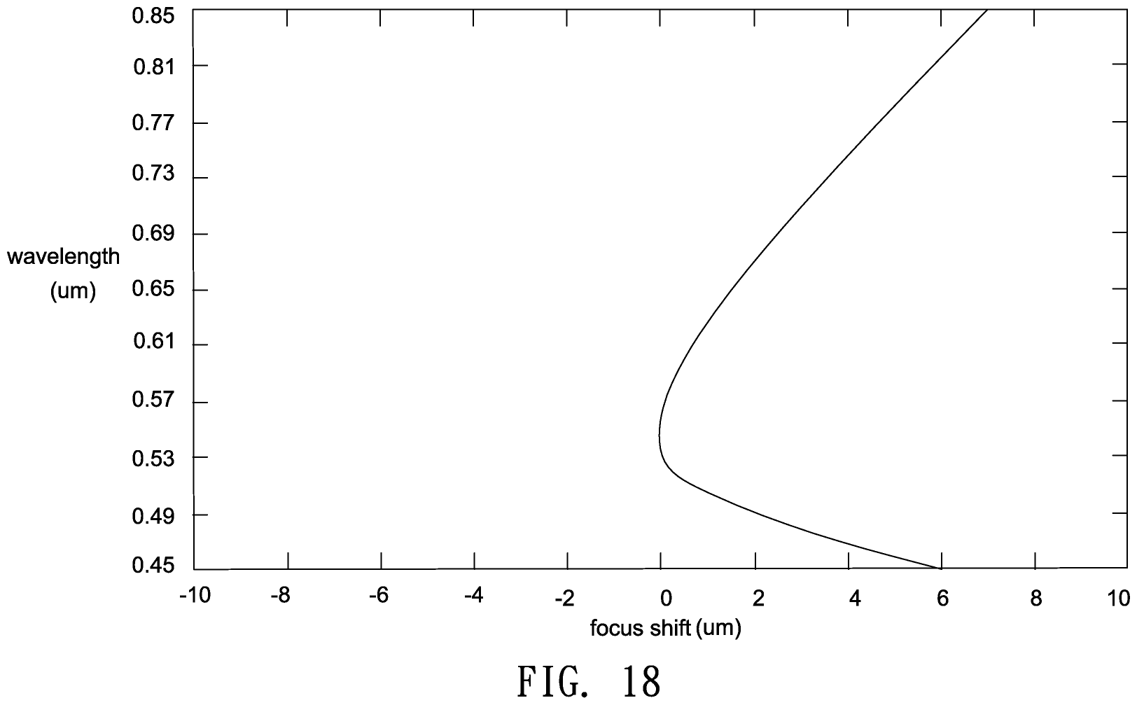

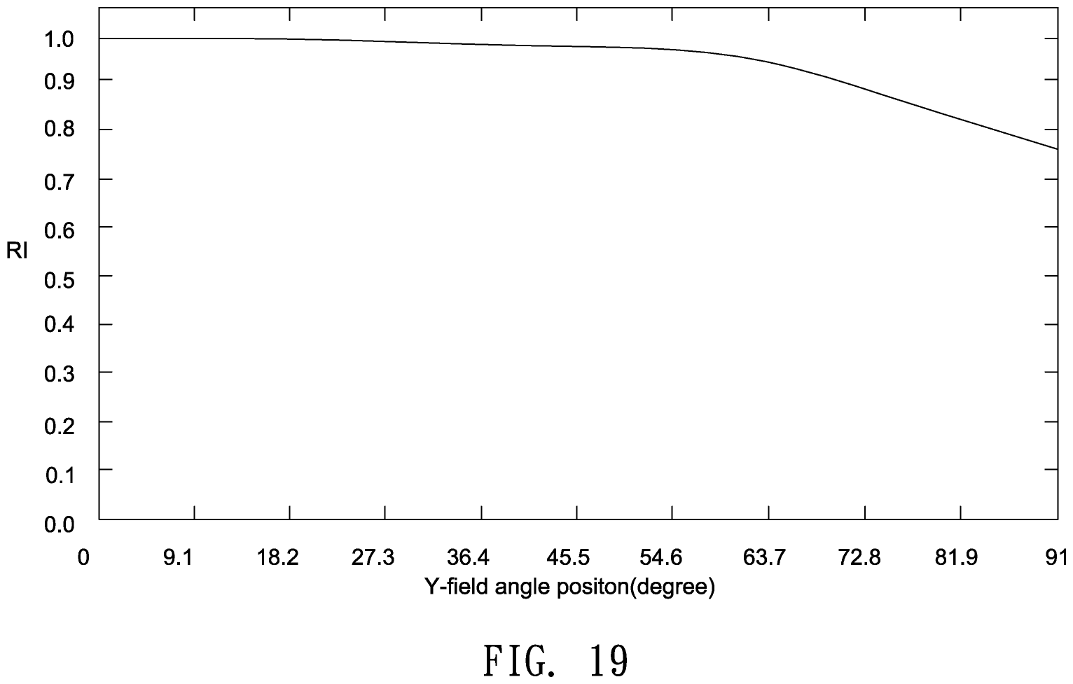

FIGS. 11, 14 and 17 respectively show ray fan plots of the optical lens 10a, 10b and 10c. FIGS. 12, 15 and 18 respectively show focus shift plots for the optical lens 10a, 10b and 10c, where each curve shows displacements of a focal plane at different wavelengths relative to a reference focal position. FIGS. 13, 16 and 19 show numerical values of relative illumination at different image heights of an image plane according to the embodiments of the optical lens 10a, 10b and 10c. The simulated results shown in FIGS. 11-19 are within permitted ranges specified by the standard, which indicates the above embodiment of the optical lens may achieve good imaging quality. Besides, FIGS. 12, 15 and 18 show a displacement between a focal plane for 450 nm visible light and a focal plane for 550 nm visible light is smaller than 10 um, and a displacement between a focal plane for 850 nm infrared light and a focal plane for 550 nm visible light is smaller than 10 um. Further, FIGS. 13, 16 and 19 show various embodiments of the invention may have high relative illumination (RI).

According to the above embodiments, the optical lens may achieve good imaging quality, low thermal drift, low fabrication costs, wide viewing angles and 24-hours confocal image-capturing capability. Further, according to the above embodiments, the optical lens is allowed to operate in a wide temperature range of −40° C. to 105° C.

Though the embodiments of the invention and design parameters in the tables have been presented for purposes of illustration and description, they are not intended to be exhaustive or to limit the invention. Accordingly, many modifications and variations without departing from the spirit of the invention or essential characteristics thereof will be apparent to practitioners skilled in this art. For example, two glass spherical lenses may be replaced with a plastic aspheric lens to reduce fabrication costs and number of lenses, or two spherical lenses may be replaced with an aspheric lens to reduce weight. Besides, the total number of lenses may be increased to enhance image resolution, or a single lens may be replaced with a cemented lens to correct chromatic aberrations. It is intended that the scope of the invention be defined by the claims appended hereto and their equivalents in which all terms are meant in their broadest reasonable sense unless otherwise indicated.

What is claimed is:

1. An optical lens, comprising:
a first lens, a second lens, a third lens, a fourth lens and a first cemented lens, the first lens being closest to a magnified side of the optical lens, one of the second lens and the third lens being a first aspheric lens, and the fourth lens being a second aspheric lens and disposed between the first cemented lens and a minified side of the optical lens; and
an aperture stop disposed between the third lens and the first cemented lens, a full field of view of the optical lens being greater than or equal to 170 degrees, a total number of lenses with refractive powers in the optical lens being in the range of seven to eleven, the optical lens having at most two plastic lenses, and the optical lens satisfying the condition:
3.5<D1/DL<5.5, where D1 denotes a lens diameter of the first lens and DL denotes a lens diameter of the fourth lens.

2. The optical lens as claimed in claim 1, wherein the optical lens further comprises a fifth lens disposed between the third lens and the first cemented lens.

3. The optical lens as claimed in claim 2, wherein the optical lens satisfies one of the following conditions:
(1) the first lens, the second lens and the fifth lens are spherical lenses;
(2) the first lens, the third lens and the fifth lens are spherical lenses.

4. The optical lens as claimed in claim 2, wherein the optical lens satisfies one of the following conditions:
(1) the optical lens further comprises a sixth lens disposed between the fifth lens and the first cemented lens;
(2) the optical lens further comprises a sixth lens, a seventh lens and an eighth lens disposed between the fifth lens and the first cemented lens, the fifth lens and the sixth lens form a second cemented lens, and the seventh lens and the eighth lens form a third cemented lens.

5. The optical lens as claimed in claim 1, wherein the optical lens satisfies one of the following conditions:
(1) the cemented lens is a cemented doublet or a cemented triplet;
(2) all lenses of the optical lens are glass lenses.

6. The optical lens as claimed in claim 1, wherein the optical lens satisfies one of the following conditions:
(1) the optical lens has eight lenses, and the eight lenses of the optical lens have respective refractive powers of negative, negative, negative, positive, positive, negative, positive and positive in order from the magnified side to the minified side;
(2) the optical lens has ten lenses, and the ten lenses of the optical lens have respective refractive powers of negative, negative, negative, positive, negative, positive, negative, negative, positive and positive in order from the magnified side to the minified side. (3) the optical lens has seven lenses, and the seven lenses of the optical lens have respective refractive powers of negative, negative, negative, positive, negative, positive and positive in order from the magnified side to the minified side;
(4) the optical lens has eight lenses, and the eight lenses of the optical lens have respective refractive powers of negative, negative, negative, positive, negative, negative, positive and positive in order from the magnified side to the minified side.

7. The optical lens as claimed in claim 1, wherein the optical lens satisfies one of the following conditions:
(1) the optical lens has eight lenses, and the eight lenses of the optical lens have respective shapes of meniscus, aspheric, biconcave, biconvex, biconvex, biconcave, biconvex and aspheric in order from the magnified side to the minified side;
(2) the optical lens has ten lenses, and the ten lenses of the optical lens have respective shapes of meniscus, meniscus, aspheric, biconvex, meniscus, biconvex, meniscus, meniscus, biconvex and aspheric in order from the magnified side to the minified side;
(3) the optical lens has seven lenses, and the seven lenses of the optical lens have respective shapes of meniscus, aspheric, biconcave, biconvex, biconcave, biconvex and aspheric in order from the magnified side to the minified side;
(4) the optical lens has eight lenses, and the eight lenses of the optical lens have respective shapes of meniscus, meniscus, aspheric, biconvex, biconvex, biconcave, biconvex and aspheric in order from the magnified side to the minified side;
(5) the optical lens has eight lenses, and the eight lenses of the optical lens have respective shapes of meniscus, meniscus, aspheric, biconvex, meniscus, biconcave, biconvex and aspheric in order from the magnified side to the minified side.

8. The optical lens as claimed in claim 1, wherein the optical lens satisfies one of the following conditions:
(1) a difference in Abbe number between two lenses of the first cemented lens is greater than 40;
(2) a difference in Abbe number between two lenses of the first cemented lens is greater than 50;
(3) a difference in Abbe number between two lenses of the first cemented lens is greater than 60.

9. The optical lens as claimed in claim 1, wherein the optical lens satisfies one of the following conditions:
(1) a thermal drift of the optical lens measured by a shift distance between a focal plane at 25 degrees and a focal plane at 105 degrees is smaller than or equal to 10 um;
(2) a displacement between a focal plane for 450 nm visible light and a focal plane for 550 nm visible light is smaller than 10 um;
(3) a displacement between a focal plane for 850 nm infrared light and a focal plane for 550 nm visible light is smaller than 10 um.

10. An optical lens, comprising:
a first lens group comprising three spherical lenses and a first aspheric lens;
a second lens group comprising a cemented lens; and
an aperture stop disposed between the first lens group and the second lens group, the optical lens comprising at most two plastic lenses, a total number of lenses with refractive powers in the optical lens being in the range of seven to eleven, an F-number of the optical lens being smaller than or equal to 2.0, a full field of view of the optical lens being greater than or equal to 170 degrees, and a relative illumination of the optical lens measured at a field of view of 170 degrees is greater than 60%.

11. The optical lens as claimed in claim 10, wherein the second lens group further comprises a second aspheric lens disposed between the cemented lens and a minified side of the optical lens.

12. The optical lens as claimed in claim 10, wherein the optical lens satisfies one of the following conditions:
(1) the cemented lens is a cemented doublet or a cemented triplet;
(2) all lenses of the optical lens are glass lenses.

13. The optical lens as claimed in claim 10, wherein the optical lens satisfies one of the following conditions:
(1) the optical lens has eight lenses, and the eight lenses of the optical lens have respective refractive powers of negative, negative, negative, positive, positive, negative, positive and positive in order from a magnified side to a minified side;
(2) the optical lens has ten lenses, and the ten lenses of the optical lens have respective refractive powers of negative, negative, negative, positive, negative, positive, negative, negative, positive and positive in order from the magnified side to the minified side;
(3) the optical lens has seven lenses, and the seven lenses of the optical lens have respective refractive powers of negative, negative, negative, positive, negative, positive and positive in order from the magnified side to the minified side;
(4) the optical lens has eight lenses, and the eight lenses of the optical lens have respective refractive powers of negative, negative, negative, positive, negative, negative, positive and positive in order from the magnified side to the minified side.

14. The optical lens as claimed in claim 10, wherein the optical lens satisfies one of the following conditions:
(1) the optical lens has eight lenses, and the eight lenses of the optical lens have respective shapes of meniscus, aspheric, biconcave, biconvex, biconvex, biconcave, biconvex and aspheric in order from a magnified side to a minified side;
(2) the optical lens has ten lenses, and the ten lenses of the optical lens have respective shapes of meniscus, meniscus, aspheric, biconvex, meniscus, biconvex, meniscus, meniscus, biconvex and aspheric in order from the magnified side to the minified side;
(3) the optical lens has seven lenses, and the seven lenses of the optical lens have respective shapes of meniscus, aspheric, biconcave, biconvex, biconcave, biconvex and aspheric in order from the magnified side to the minified side;
(4) the optical lens has eight lenses, and the eight lenses of the optical lens have respective shapes of meniscus, meniscus, aspheric, biconvex, biconvex, biconcave, biconvex and aspheric in order from the magnified side to the minified side;
(5) the optical lens has eight lenses, and the eight lenses of the optical lens have respective shapes of meniscus, meniscus, aspheric, biconvex, meniscus, biconcave, biconvex and aspheric in order from the magnified side to the minified side.

15. The optical lens as claimed in claim 10, wherein the optical lens satisfies one of the following conditions:
(1) a difference in Abbe number between two lenses of the cemented lens is greater than 40;
(2) a difference in Abbe number between two lenses of the cemented lens is greater than 50;
(3) a difference in Abbe number between two lenses of the cemented lens is greater than 60.

16. The optical lens as claimed in claim 10, wherein the optical lens satisfies one of the following conditions:
(1) a thermal drift of the optical lens measured by a shift distance between a focal plane at 25 degrees and a focal plane at 105 degrees is smaller than or equal to 10 um;
(2) a displacement between a focal plane for 450 nm visible light and a focal plane for 550 nm visible light is smaller than 10 um;
(3) a displacement between a focal plane for 850 nm infrared light and a focal plane for 550 nm visible light is smaller than 10 um.

17. An optical lens, comprising:
a first lens with a negative refractive power, a second lens with a negative refractive power, a third lens with a negative refractive power, a fourth lens with a positive refractive power, a fifth lens with a refractive power, a sixth lens with a refractive power and a seventh lens with a positive refractive power arranged in order in a direction, at least two of the first lens, the second lens and the third lens being glass spherical lens, the fifth lens and the sixth lens being combined to form a cement lens, and the seventh lens being an aspheric lens; and
an aperture stop disposed between the fourth lens and the fifth lens, wherein a total number of lenses with refractive powers in the optical lens is no more than eleven, and the optical lens has at most two plastic lenses.

18. The optical lens as claimed in claim 17, wherein the optical lens further comprises an eighth lens with a positive refractive power disposed between the fourth lens and the cemented lens.

19. The optical lens as claimed in claim 17, wherein the optical lens satisfies one of the following conditions:
(1) the optical lens has eight lenses, and the eight lenses of the optical lens have respective shapes of meniscus, aspheric, biconcave, biconvex, biconvex, biconcave, biconvex and aspheric in order from a magnified side to the minified side;
(2) the optical lens has ten lenses, and the ten lenses of the optical lens have respective shapes of meniscus, meniscus, aspheric, biconvex, meniscus, biconvex, meniscus, meniscus, biconvex and aspheric in order from the magnified side to the minified side;
(3) the optical lens has seven lenses, and the seven lenses of the optical lens have respective shapes of meniscus, aspheric, biconcave, biconvex, biconcave, biconvex and aspheric in order from the magnified side to the minified side;
(4) the optical lens has eight lenses, and the eight lenses of the optical lens have respective shapes of meniscus, meniscus, aspheric, biconvex, biconvex, biconcave, biconvex and aspheric in order from the magnified side to the minified side;
(5) the optical lens has eight lenses, and the eight lenses of the optical lens have respective shapes of meniscus, meniscus, aspheric, biconvex, meniscus, biconcave, biconvex and aspheric in order from the magnified side to the minified side.

20. The optical lens as claimed in claim 17, wherein the optical lens satisfies one of the following conditions:
(1) a difference in Abbe number between two lenses of the cemented lens is greater than 40;
(2) a difference in Abbe number between two lenses of the cemented lens is greater than 50;
(3) a difference in Abbe number between two lenses of the cemented lens is greater than 60;
(4) a thermal drift of the optical lens measured by a shift distance between a focal plane at 25 degrees and a focal plane at 105 degrees is smaller than or equal to 10 um;
(5) a displacement between a focal plane for 450 nm visible light and a focal plane for 550 nm visible light is smaller than 10 um;
(6) a displacement between a focal plane for 850 nm infrared light and a focal plane for 550 nm visible light is smaller than 10 um.
